(19) United States
(12) Patent Application Publication
(10) Pub. No.: US 2013/0047530 A1
(43) Pub. Date: Feb. 28, 2013

(54) HOLLOWCORE SLABS

(71) Applicants: JOHN ANTHONY BRUCE DOUGLAS DURHAM, London (GB); Nigel Francis Maydew, Cirencester (GB); Howard Peter John Taylor, Pilton (GB)

(72) Inventors: JOHN ANTHONY BRUCE DOUGLAS DURHAM, London (GB); Nigel Francis Maydew, Cirencester (GB); Howard Peter John Taylor, Pilton (GB)

(21) Appl. No.: 13/653,646

(22) Filed: Oct. 17, 2012

Related U.S. Application Data
(63) Continuation of application No. PCT/GB2011/050507, filed on Mar. 15, 2011.

(30) Foreign Application Priority Data
Mar. 16, 2010 (GB) 1004333.9

(51) Int. Cl. B29C 39/26; E04C 2/52; B29C 39/24; E04C 1/00

(52) U.S. Cl. 52/220.1; 52/576; 249/63; 264/313

(57) ABSTRACT

Hollowcore apparatus for forming a concrete hollowcore slab, comprises a casting bed, side wall elements extending longitudinally of the casting bed for defining sides of a casting mould, at least one non-sacrificial inflatable core former, at least one, preferably non-sacrificial sleeve for substantially receiving the core former, the core former and the sleeve being interconnected and the in use sleeve being turnable inside out by removal of the core former from the casting bed, and at least one holder for preventing or limiting uplift of the in use inflated core former and sleeve relative to the casting bed. A method and hollowcore slab are also provided.

### RELATED APPLICATIONS

This is a continuation of International Application PCT/GB2011/050507 with an international filing date of Mar. 15, 2011.

### BACKGROUND

The invention relates to hollowcore apparatus for forming a concrete hollowcore slab, a method of forming a concrete hollowcore slab, and a hollowcore slab formed using such apparatus and/or such a method.

Hollowcore slabs are well known and used in numerous applications and situations. A hollowcore slab is a reinforced or prestressed precast concrete slab which is used as a floor or wall slab/panel in applications in residential, commercial and industrial structures.

The known slab is rectangular in cross section with hollow voids at its central depth which have the effect of lightening the slab without significantly reducing its strength. Commonly, the slabs are between 150 mm and 600 mm in depth but deeper slabs are being considered.

The voids or cores in the cross section of the slabs are prismatic in cross section and are commonly circular, particularly in the shallow slabs, with deeper slabs using oval or square cores. The voided percentage of the unit cross section is commonly in the range of 40% to 60%.

Voided prestressed and reinforced concrete slabs are not new. Originally they were made by having lost inserts to form the voids. The cast in lost inserts have been card or plastics.

In known applications, the concrete has been a conventional mix and has been compacted by vibration.

Hollowcore slabs are manufactured using four main methods: extrusion; slip-forming; shear compaction; and hydraulic extruder. However as the slabs were developed to be deeper and the spans therefore became longer a number of disadvantages became apparent and which either limit further development, or make the slab inappropriate for its intended application.

Conventionally, a hollowcore slab is cast on a prestressing bed of length depending on the production system to be used. The bed is usually fixed but can be moveable and is usually in the order of 50 to 200 metres in length. The casting line is topped with a steel pallet upon which the product is cast and beneath which, commonly, pipes to carry steam, hot water or hot oil are provided to assist the curing of the concrete unit once it is made. Other means of curing may also be provided.

For the manufacture of prestressed hollowcore slabs, jack heads of concrete and steel are provided and between these the steel tendons/strands are run and which eventually provide the prestress in the unit. The strands are stressed by pulling them with jacks, either individually or together and are anchored to the jack heads. The thrust onto the jack heads from the prestress may be in the order of a few hundred tons and this is carried in the floor or in part of the manufacturing bed between the jack heads at each end of the production line.

When the line has been stressed the hollowcore manufacturing machines are started, filled with concrete and generally, automatically, pass down the line.

The prestress in the steel strands is eventually transmitted into the hollowcore slabs by surface bond and therefore it is important that strong well consolidated concrete is always used.

For the slip forming technique, the hollowcore machine is towed or is driven along the production line leaving the hollowcore slab behind. The machine, being independent of the mix it is casting, creates the possibility of inferior final slab quality.

For the extrusion technique, the hollowcore machine is propelled along the line by exerting pressure in the fresh concrete of the hollowcore slab that it leaves behind. The machine is neither self propelled or pulled. The slab is therefore extruded. European Patent Application 92305088.4 describes the hollowcore extrusion method of manufacture.

For the shear compaction technique, an adaptation of the extrusion process specifically developed to try and reduce noise and wear of main parts of the machine whilst operating is provided. Strength of the resultant concrete is compromised, however, necessitating the reduction of the stressing load on the strands requiring proportionally more strand than the pure extrusion process.

For the hydraulic pulsating extruder technique, the hollowcore machine is pushed along the line by the action of forcing concrete into a chamber with steel cores/tubes passing there through. The continuous forcing action, for example, a pulse every 5 to 10 seconds, moves the machine away from the compacted concrete. Spare parts replacements are reduced with this new technology when compared to the Extrusion process.

These aforementioned mechanical processes have several great disadvantages.

As the machine can only pass over longitudinal prestressing strand reinforcement it is impossible to provide transverse reinforcement horizontally or vertically. Secondary binding steel, links, stirrups, ties, and so forth also cannot be provided during forming. These secondary unstressed reinforcements are essential in parts of the world where seismic events are expected and have to be considered in the design. These factors limit the use of hollowcore slabs in buildings where high accidental forces may occur.

The only way that these kinds of unstressed reinforcements can be inserted is by manual labour following behind the machine to remove the freshly cast concrete locally, insert the reinforcement or other fittings and manually repack the void with more fresh concrete which can then be consolidated. Even with this method, it is impossible to install rectangular links or stirrups which are conventionally used in concrete elements to carry shearing forces, making hollowcore slabs less suitable for long span applications.

It is also impossible to cast in any form of fitting, inserts, threaded sockets, conduits and conduit lines, or temperature/humidity sensors because they would interrupt the operation of the machine.

Hollowcore machines must make a continuous uninterrupted length of product, usually to the full length of the long casting line. It is impossible for discreet short lengths to be manufactured because of the extreme difficulty and cost of removing under-utilised lengths of steel strand.

The continuous cast length of hollowcore slab formed using the known methods must then be cut, after curing, into individual lengths by a mechanical cutter. Saws are expensive and use a continuous supply of large diameter saw blades. A large quantity of potable water is also required to cool the blades resulting in an environmentally and difficult to manage slurry which has to be disposed of. The sawing process is a serious time constraint on the manufacturing process. Currently, health and safety regulations demand that saw cutting operators are confined in a secure control cabin, generally mounted on the saw to eliminate noise and ingress of the detritus from cutting, further increasing the capital cost of the saw.

The saw, in many respects, is therefore as complicated a piece of machinery as the hollowcore machine. These two machines, in symbiosis with each other, are fundamental to a present modern hollowcore production facility. Both machines devour spare parts and consumables at alarming rates, with a continuing use of electricity and large volumes of potable water, attended by highly competent operators, mechanics and electricians to ensure they operate effectively with the minimum of downtime.

Hollowcore machines commence casting as near as possible to one end of the line. The first batch of concrete passes through the machine before the machine can make a suitable first slab length. Similarly before the machine reaches the end of the line it continues casting past the end of the first slab length to ensure it maintains a satisfactory shape. The wasted mix at both ends of the line is also bonded with the prestressing strand. Once the strands are de-stressed and the slabs removed, the wasted ends have to be crushed, disposed of and the strand cut up to be possibly used as off-cuts. Again, this causes increased expense in terms of wasted time and environmental impact.

Presently known hollowcore machines also have the disadvantage that they are expensive to maintain and continually need spare parts because of the great wear that the reciprocating, vibrating and slipping parts experience from contact with the fresh concrete.

Present hollowcore machines also have the great disadvantage that they are very noisy requiring great care in protection of the operatives from hearing damage.

Present hollowcore machines also have the disadvantage that they can cause injury to the operatives as some machine types vibrate excessively as they place the concrete, necessitating protective cages around the machines.

The known hollowcore machines also have the disadvantage that they are generally used in large fixed factory locations which require expensive cranes and gantries to lift and service them and supply them with fresh concrete. They are not suitable for use in temporary site locations or for sites which are very distant from the factory unless there is an individual site requirement for upwards 20,000 m².

Prestressing strands used in hollowcore slabs have a precisely designed location. Despite the fact that special locking devices endeavour to maintain the strands in the correct location inevitably because of the compacting pressure and vibration imparted by the hollowcore machine, very often the strands as they leave the locating device become out of alignment. Slabs where these strands are misplaced could possibly be rejected as being out of the strict dimensional specification.

Hollowcore slabs are lifted from the production line by special scissor clamps connected to a lifting beam held by an overhead crane. Again, this necessitates a large and permanent structure, making use unsuitable for temporary sites. Safety devices, such as chains surrounding the slab at both ends to ‘catch’ the slab in the event of the slab shearing away from the clamp on the slab sides are mandatory. For long slabs, scissor clamps are now rarely used and expensive hydraulic clamps are the preferred option. However, health and safety officers are increasingly looking for even safer means of handling long individual slabs. The only solution is a time consuming operation to remove the concrete, immediately after casting the concrete, on the upper surface of the slab to expose the cores set back from the four corners of each slab. Heavy duty lifting loops are then cast into the void using additional vibrated fresh concrete enabling the slab to be lifted safely without the need for additional safety procedures such as chains.

There is very often a requirement to make a horizontal cross connection between adjacent voids/cores in a hollowcore slab. This allows the passage of air to pass uninterrupted from one core to another and even possibly to a third core. Using existing methods of hollowcore manufacture, the only means of creating a cross connection is to manually core drill the slab after it has been removed from the casting line and installed on site.

As well as cross connections between the cores there is also a requirement to drill 120 to 160 mm diameter holes directly into the soffit of the slabs. This operation also takes place on site generally involving ‘vacuum anchoring’ upwards core drilling apparatus. All on site core drilling operations involve expensive health and safety managed labour operations, machinery and cleaning apparatus to remove unwanted detritus.

It would be an advantage to add steel fibres into a hollowcore mix, effectively introducing the equivalent of secondary reinforcement and dramatically improving the shear capacity of a typical hollowcore slab allowing for longer spans. Current hollowcore machines preclude the use of steel fibres because the low water content in the mix creates a very stiff mix essential to allow efficient compaction of the mix by the hollowcore machine. The mix is therefore not fluid enough to distribute the fibres evenly creating bunching of fibres and the action of rotating or reciprocating devices to create the cores/voids of the slab would also compromise the operation of the machine.

The invention seeks to provide a unique method of manufacturing a hollowcore precast concrete slab which allows the slab to have a number of features which are impossible to provide in a conventionally machine-cast hollowcore slab, and which provides a solution to the above mentioned problems.

### SUMMARY

According to a first aspect of the invention, there is provided hollowcore apparatus for forming a concrete hollowcore slab, the apparatus comprising a casting bed, side wall elements extending longitudinally of the casting bed which define sides of a casting mould, at least one non-sacrificial inflatable core former, at least one non-sacrificial sleeve in which at least part of the core former is receivable, the core former and the sleeve being interconnected and the in use sleeve being turnable inside out by removal of the core former from the casting bed, and at least one holder which prevents or limits uplift of the in use inflated core former and sleeve relative to the casting bed.

According to a second aspect of the invention, there is provided a method of forming a concrete hollowcore slab, the method comprising the steps of: a) preparing a casting mould; b) locating at least one non-sacrificial inflatable core former having a non-sacrificial sleeve connected thereto in the casting mould; c) providing at least one holder for preventing or limiting uplift of the inflated core former and sleeve; d) inflating the core former; e) pouring concrete into the casting mould to cover the core former and sleeve; f) deflating the core former and the sleeve once the concrete hardens, and removing the core former and the sleeve by drawing the core former out causing the connected sleeve to turn inside out and thus also be drawn out; and g) removing the hollowcore slab from the casting bed.

According to a third aspect of the invention, there is provided a method of forming a concrete hollowcore slab, the method comprising the step of pouring concrete into a casting mould having therein at least one non-sacrificial inflated core former having a non-sacrificial sleeve therearound, the core former and sleeve being interconnected at one end so that on withdrawal of the core former the sleeve is turned inside out, the inflated core former and sleeve being restrained against substantial uplift by a holder in or on the casting mould.

According to a fourth aspect of the invention, there is provided a hollowcore slab formed in accordance with the first aspect of the invention and self-compacting concrete, having a fluid-flow pipe therein whereby the hollowcore slab is adapted for use as a thermal energy store and/or secondary radiator.

The invention will now be more particularly described, by way of example only, with reference to the accompanying drawings.

### BRIEF DESCRIPTION OF THE DRAWINGS

FIG. 1a shows a diagrammatic perspective view of part of one embodiment of hollowcore apparatus, in accordance with the first aspect of the invention;

FIG. 1b is a lateral cross-section in elevation of the hollowcore apparatus, shown in FIG. 1a and when in use;

FIG. 1c is a lateral cross-section of the casting bed and longitudinal side wall shutters, showing the shutters pivoting;

FIG. 1d is a lateral elevation showing a joint between opposing sides of two cast hollowcore slabs;

FIG. 1e shows prior art lifting clamps required for a plurality of different depths of hollowcore slabs formed using known casting techniques;

FIG. 1f is a lateral end view of the hollowcore apparatus, in accordance with the first aspect of the invention;

FIG. 2a is a perspective view of the hollowcore apparatus as shown in FIG. 1, with additional elements shown;

FIG. 2b is a diagrammatic perspective view of a divider of the hollowcore apparatus, shown in FIG. 2a;

FIG. 3 is a lateral elevational view of a hollowcore slab in accordance with the third aspect of the invention and cast using the hollowcore apparatus of the second aspect of the invention, and showing positions of groups of strand wires and cores or voids;

FIGS. 4a and 4b show elevational lateral views of a flexible unit which is locatable on the divider between spaced walls;

FIG. 5a diagrammatically shows in perspective view further parts of the hollowcore apparatus of the present invention;

FIGS. 5b and 5c are top plan views of apparatus for first and second methods, respectively, of deploying inflatable core formers and sleeves;

FIG. 5d is an elevational longitudinal view of one end of the casting bed and shutters, showing parked carriage;

FIG. 5e is a perspective representation of a carriage;

FIG. 6 is a perspective view of the divider with upper dividers thereon and the inflatable core formers and sleeves extending therethrough;

FIG. 7a shows a perspective view of a capping piece utilised as part of the hollowcore apparatus of the invention;

FIG. 7b is an elevational lateral cross-section of part of the hollowcore apparatus showing the capping piece in use;

FIG. 8 shows an elevational lateral cross-section of the hollowcore apparatus of the invention and in which can be seen a holder;

FIG. 9(a) shows a second kind of holder having extended loops;

FIG. 9(b) is a diagrammatic representation of the hollowcore slab of the third aspect of the invention having holders with extended loops and being lifted by a lifting device, such as a crane and by multiplying similar loops in a typical hollowcore slab they can act as shear connectors to a structural topping screed.

FIG. 10 is an elevational lateral cross-sectional view showing the hollowcore apparatus in use and with a prong device for holding the strand wires in place;

FIG. 11a is a perspective view showing mesh reinforcement of the hollowcore apparatus of the present invention;

FIG. 11b is an elevational lateral cross-section of a cast hollowcore slab showing an interconnection between upper steel bar and lower strand wires;

FIG. 11c shows an end of a horizontal reinforcing bar with angled ends to locate in a portion of a shutter;

FIGS. 12a, 12b, 12c and 12d show representations of half-jointed ends of hollowcore slabs, formed using hollowcore apparatus of the invention;

FIG. 12e is a perspective view of part of the hollowcore apparatus of the invention, showing block outs for forming access openings to the cores or voids;

FIG. 12f is a lateral end view of a block out in relation to an inflatable core former, sleeve and shutter;

FIG. 13a is an elevational view showing two opposing walls with corbels and a hollowcore slab located thereon;

FIG. 13b shows a half-jointed end of a hollowcore slab formed using hollowcore apparatus of the invention and engaged with a wall corbel;

FIGS. 13c and 13d show perspective views of voided areas of the ends of hollowcore slabs formed using hollowcore apparatus of the invention;

FIGS. 14a and 14b are diagrammatic views of inserts which can be provided in a casting mould of the hollowcore apparatus prior to casting the hollowcore slab;

FIGS. 15a to 15c show the provision of water pipes in the casting mould of the hollowcore apparatus prior to casting the hollowcore slab;

FIGS. 16a to 16c shows perspective views of typical access openings into hollowcore slabs;

FIGS. 16d to 16q show cross-connections or galleries between cores or voids, and formers for forming the cross-connection and access openings;

FIG. 17a shows a feed skip above the hollowcore apparatus of the present invention;

FIGS. 17b and 17c show two kinds of restraining bar utilised for preventing uplift of the inflatable core formers and sleeves during concrete pouring;

FIG. 17d is a perspective view of part of the casting bed and shutters of the hollowcore apparatus, showing the restraining bars;

FIG. 17e shows the carriage with reeling drum and curing sheet;

FIG. 18 is an elevational longitudinal view of an end of the hollowcore apparatus, showing an air valve of the inflatable core former and the carriage mounted on the shutters;

FIG. 19a shows elements of the hollowcore apparatus of the invention used in a first method of extracting the inflatable core formers and sleeves from the cast hollowcore slab of the present invention;

FIGS. 19b to 19e show elements of the hollowcore apparatus of the invention used in a second method of extracting the inflatable core formers and sleeves from the cast hollowcore slab of the present invention, FIG. 19(b)(2) is an enlarged view of the portion including reference 25 in FIG. 19(b)(1);

FIGS. 19f to 19j shows elements of the hollowcore apparatus of the invention used in a fourth method of extracting the inflatable core formers and sleeves from the cast hollowcore slab of the present invention;

FIG. 20a shows part of the hollowcore apparatus, in accordance with the first aspect of the invention, and a guide for guiding the core formers and sleeves being extracted;

FIGS. 20b to 20g show in diagrammatic form the problems associated with the fifth method of extracting a deflated core former and sleeve from a cast hollowcore slab of the present invention;

FIGS. 21a to 21d show an alternative method of sealing the ends of a typical hollowcore floor slab; and

FIGS. 22a to 25c depict ruching techniques of the present invention for the sleeves of the hollowcore apparatus.

### DETAILED DESCRIPTION OF THE PREFERRED EMBODIMENTS

The process described hereinafter is a complete production cycle. By way of example, this description starts with a clean hollowcore casting bed and explains the preparation of the bed to make hollowcore slabs; the casting of the hollowcore slab; and the specific ‘off’ critical path preparation necessary to remove the slab from the casting area creating a clean hollowcore bed once again.

The process described is by way of example only, and various options are provided which largely depend on the size of the casting bed and the size of the hollowcore slabs required. However, the embodiments and modifications described herein and throughout are provided by way of examples only, and various other modifications will be apparent to persons skilled in the art without departing from the scope of the invention as defined by the appended claims.

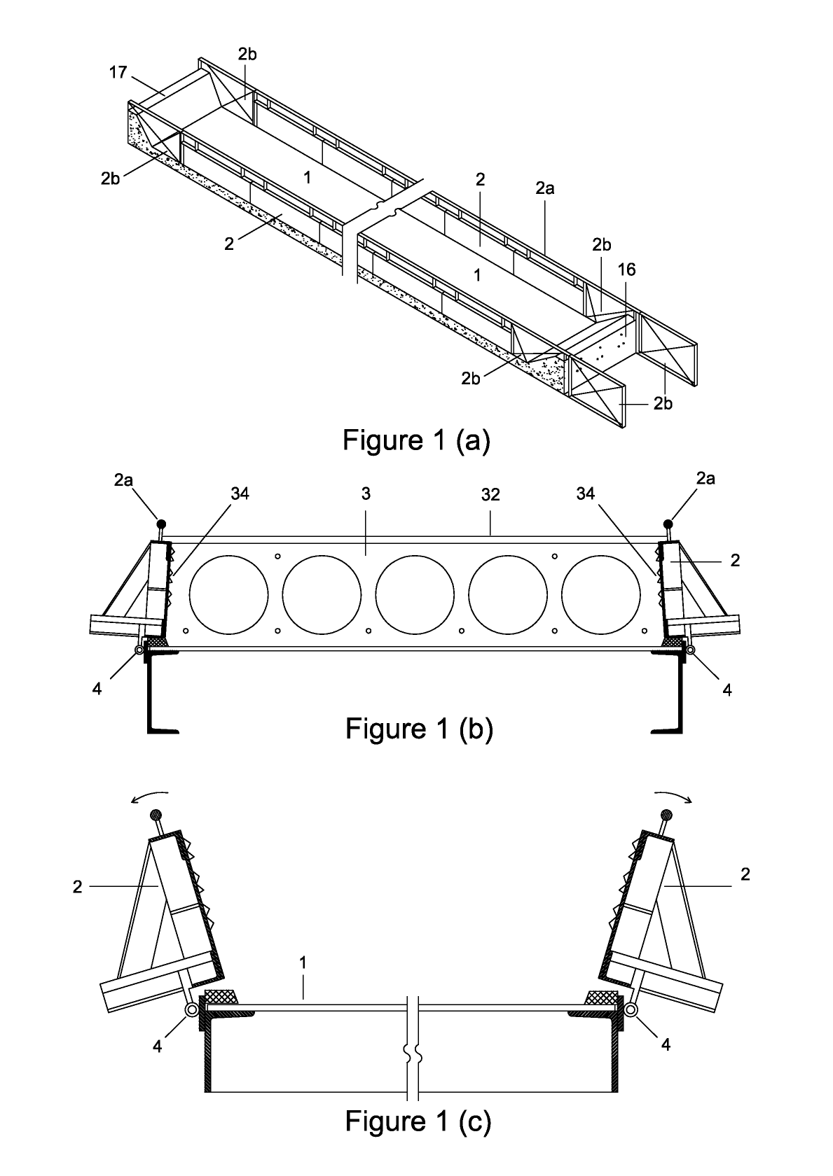

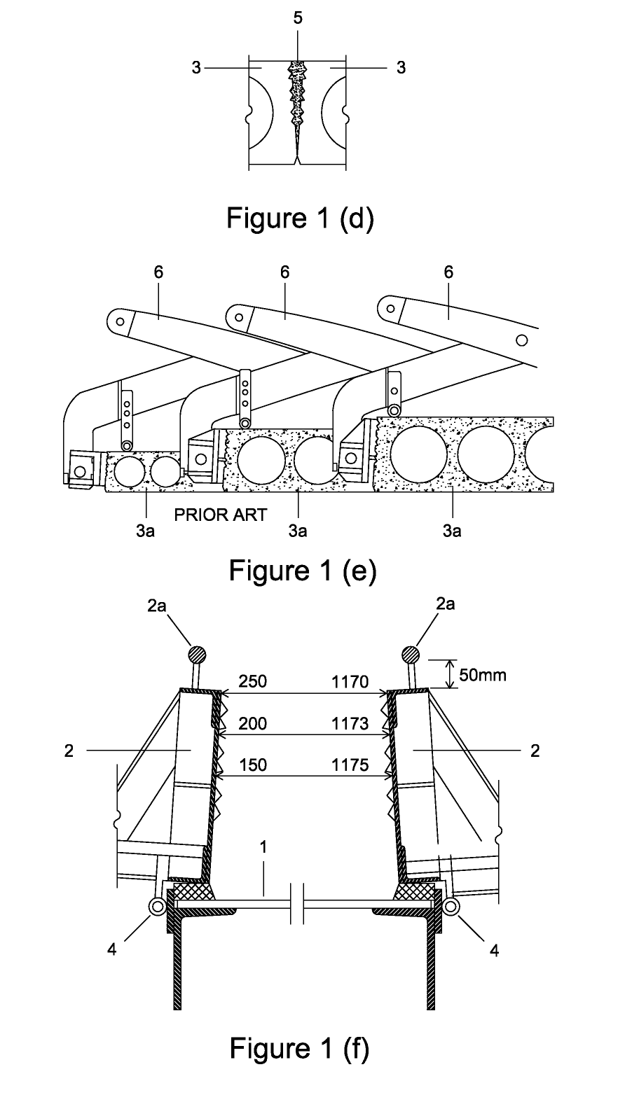

FIG. 1(a) shows a 300 to 2400 mm wide from 10 to 200 metre long casting line 1, utilised to produce individual hollowcore slabs. Casting line 1 has shutters 2 attached to each side of and running along the full length of casting line 1. The shutters 2 may be manually movable or driven by motors and/or hydraulic/pneumatic. Shutters 2 create the angled sides of a typical length of hollowcore slab hollowcore slab 3 to be cast. See FIG. 1(b). Shutters 2 are pivotably connected to the bed of the casting line 1 via hinges 4 and can be angled outwards to 90 degrees but preferably angled to a max of 15 degrees to save space either side of the casting line 1. See FIG. 1(c). Hinging shutters 2 away from casting line 1 allows uninterrupted space when preparing the line for production. The depth of shutters 2 is the required depth of an individual hollowcore slab 3 to be cast or they can be made to accommodate a series of varying slab depths, for example from 150 mm up to 600 mm.

Indents, in the side of shutters 2, ultimately formed in the side of all individual hollowcore slabs 3 to meet requisite design codes, are provided to form an anchoring key or wedge for cement mortar grout 5 to be poured between two adjacent hollowcore slabs 3 once installed on site. See FIG. 1(d). The wedge will reduce the width of the top of the slab 3 by approximately 30 mm. With, by way of example, a 1200 mm base width of a hollowcore slab 3 the top width would therefore be 1170 mm. In traditional machine-made hollowcore slabs 3a, standard indents allow lifting clamps 6 in FIG. 1(e) to grip the sides of the slab 3a, remove the individual hollowcore slab 3a and transport to site. A specially designed set of lifting clamps 6 may be required for every depth of traditional slab 3a.

FIG. 1(f) shows preferable 250 mm deep shutters 2 to make 150 mm, 200 mm and 250 mm depth of hollowcore slabs 3 by way of example. Shutters 2, once folded in to their casting condition, will always have a fixed set angle for the variety of accommodated slab depths. In other words, for the range of slab depths, the shutters do not have to be set at different angles for different slab depths. The width of the top of hollowcore slab 3, being 1170 mm for the 250 mm deep hollowcore slab 3, would make the top width of the 200 and 150 mm hollowcore slabs 3 some 3 to 5 mm wider. However, as the new hollowcore technology does not use or require independent lifting clamps 6, varying top widths of hollowcore slabs 3 can always be accommodated. Not only does this enable the engineer to specify different sizes of grout spacing 5 but the factory is not encumbered with numerous sets of varying sized lifting clamps 6.

Individual lengths of shutters 2, up to for example 6 metres long, can be hinged independently from adjacent lengths of shutters 2, at each side of casting line 1. Elongate round metal rail 2a is supported by the top surface of the shutter 2. See FIG. 1(f). A gap of at least 50 mm remains between the top of shutters 2 and the underside of rail 2a. Intermittent welded struts along the tops of shutters 2 ensure rail 2a remains rigidly and equi-distantly fixed to the independent lengths of shutters 2 allowing them to hinge outwards as described. Rail 2a continues beyond the ends of shutters 2 to the end 17 of casting line 1 and approximately 1 metre beyond the end 16. These short lengths or shutter portions supported by frame 2b, though not linked to side shutters 2, hinge outward to the same angle as side shutters 2. See FIG. 1(a). With shutters 2 locked into place, ready for casting, or hinged outwards for de-moulding, rail 2a provides an uninterrupted horizontal and continuous straight rail line over the whole production length.

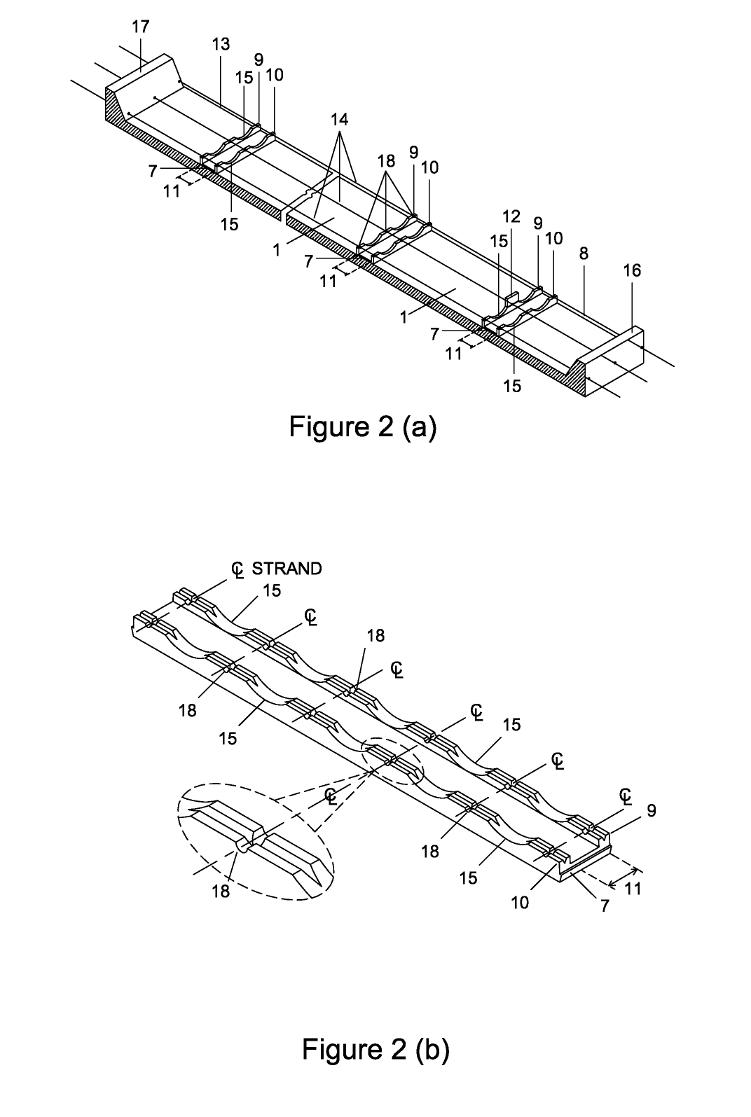

Factory personnel prepare casting line 1 to cast individual lengths of hollowcore slabs 3 as follows. Shutters 2 remain hinged outwards as in FIG. 1(c). A flat bottomed strand locator base plate 7 magnetically anchored to casting line 1 in FIG. 2(a) wherein shutters 2 on each side of casting line 1 are omitted for clarity is placed at end 8 of casting line 1. At each edge of base plate 7, spanning across the full width of casting line 1, raised lower dividers 9, 10 are included, precisely identifying the required positions for the strands 14 to pass each side of the cores or voids of the proposed hollowcore slab 3. The width 11 of base plate 7 between the inner faces of dividers 9 and 10 can vary from 10 mm up to 300 mm FIG. 2(b) shows an enlarged view of a typical base plate 7, in accordance with the invention.

Although separate dividers 9 and 10 are suggested on base plate 7, a single lower divider having a strand cutting slot therein could be utilised.

A laser sighting target 12 is placed on the edge of the outer surface of divider 9 and the operator walks along casting line 1 and measures by a mobile laser device the exact length of the first individual hollowcore slab 3. Equally a tape measure could be used instead of a laser. At this point a second base plate 7 is preferably magnetically anchored to casting line 1 with the divider 10 positioned at the theoretical proposed lateral end of the individual hollowcore slab 3. The operation is then repeated down the full length of casting line 1 to end 13 of casting line 1 with the operator ensuring all base plates 7 are laid at right angles to the longitudinal extent of casting line 1. Thus, the lateral ends of each cast hollowcore slab 3 are 90 degrees to their longitudinal sides. It should be noted that the initial base plate 7 is set at the end 8 of casting line 1, thereby keeping strand wastage to a minimum, as will be understood hereinafter. As much of casting line 1 as possible will be utilised to cast individual hollowcore slabs 3, of varying lengths to the nearest centimetre, to suit the production schedule. For example, there could be up to twenty eight base plates 7 for each casting line 1, entirely dependent on the individual hollowcore slab lengths required and the overall length of casting line 1.

Prestressing elongate flexible elements, typically being the strand wires 14, are then laid down the length of casting line 1. The laterally spaced apart bottom curved recesses 15 of dividers 9 and 10 form the future underside radiused locations of the core or void formers. The dividers 9 and 10 provide suitable locators 18 to ‘run’ groups of strand wires 14 down casting line 1. When strand wires 14 have been anchored to the strand locator plates 16 and 17 at the ‘dead end’ of the casting line 1, see FIG. 2a, and at the ‘live end’, they are partially stressed to take out the slack. Factory labour or automated machinery then move individual strand wires 14 into each semi circular slot locator 18 which has the same or matching diameter as strand wires 14 and is recessed into the top surface of dividers 9 and 10 on all base plates 7. Thereafter strand wires 14 are fully stressed in the conventional manner from end 13.

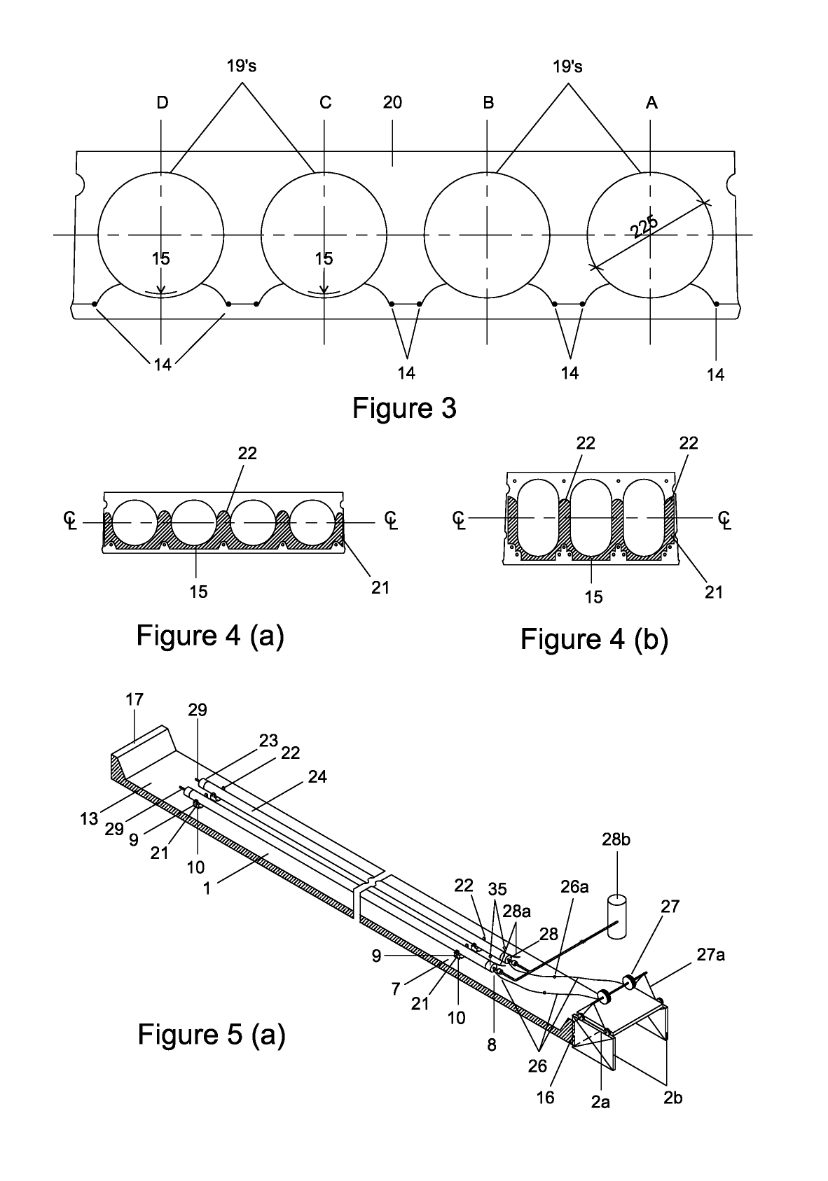

The single strand wires 14 configuration between each proposed core/void as shown in FIG. 2a is for relatively low dead loads to be applied to the finished hollowcore slabs 3. For high dead loads the quantity of strand wires 14 increases as well as the depth of the hollowcore slab 3 particularly for longer spans. Varying depths of slab sections will also dictate the number of cores or voids 19 that can be created in the cross section 20, as in FIG. 3 by way of example. For clarification, for the remainder of the description cores or voids 19 in FIG. 3 are identified as A, B, C and D. Individual base plates 7 are therefore designed to accommodate not only a varying quantity of cores or voids 19 defined via the curved recesses 15, but also varying configurations for single or multiple strand wires 14 with different diameters between any two cores or voids 19.

A polyurethane unit or similar of flexible material forming a guide unit 21, shown in FIG. 4(a), is now inserted over the strand wires 14 and in the cutting gap or between dividers 9 and 10. Flexible guide unit 21 is preferably a one-piece casting or moulding and extends across the full width of the hollowcore slabs 3. The bottom curve of flexible guide unit 21 follows curved recess 15 in FIG. 2 and FIG. 3, so that the respective radii match. The top of flexible guide unit 21 continues past the theoretical horizontal centre line of the proposed cores or voids 19 and terminates at the top of walls 22. Similarly in FIG. 4(b), where deep elongate oval cores or voids 19 are required, walls 22 extend a considerable distance vertically past the horizontal centre line of the proposed cores or voids 19. Flexible guide units 21 can be inserted on every base plate 7 on the casting line 1 as required, and serve as an accurate locating guide for the core former/s to be laid thereon.

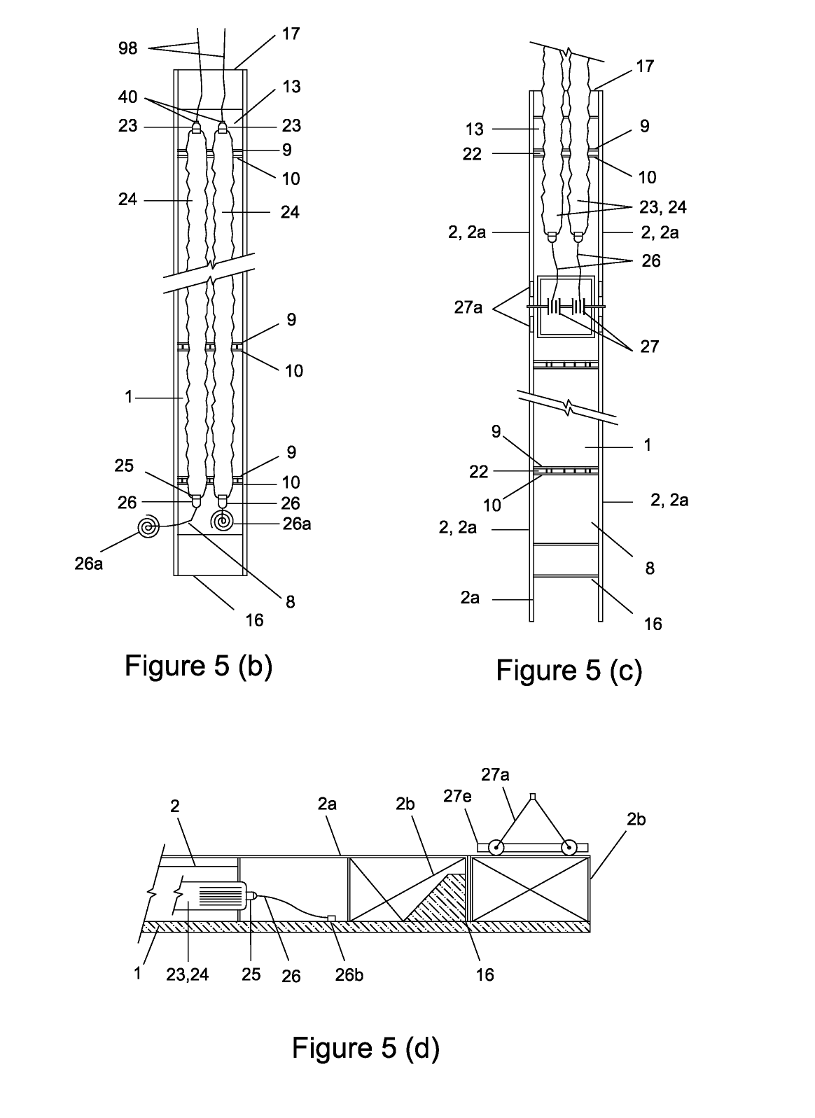

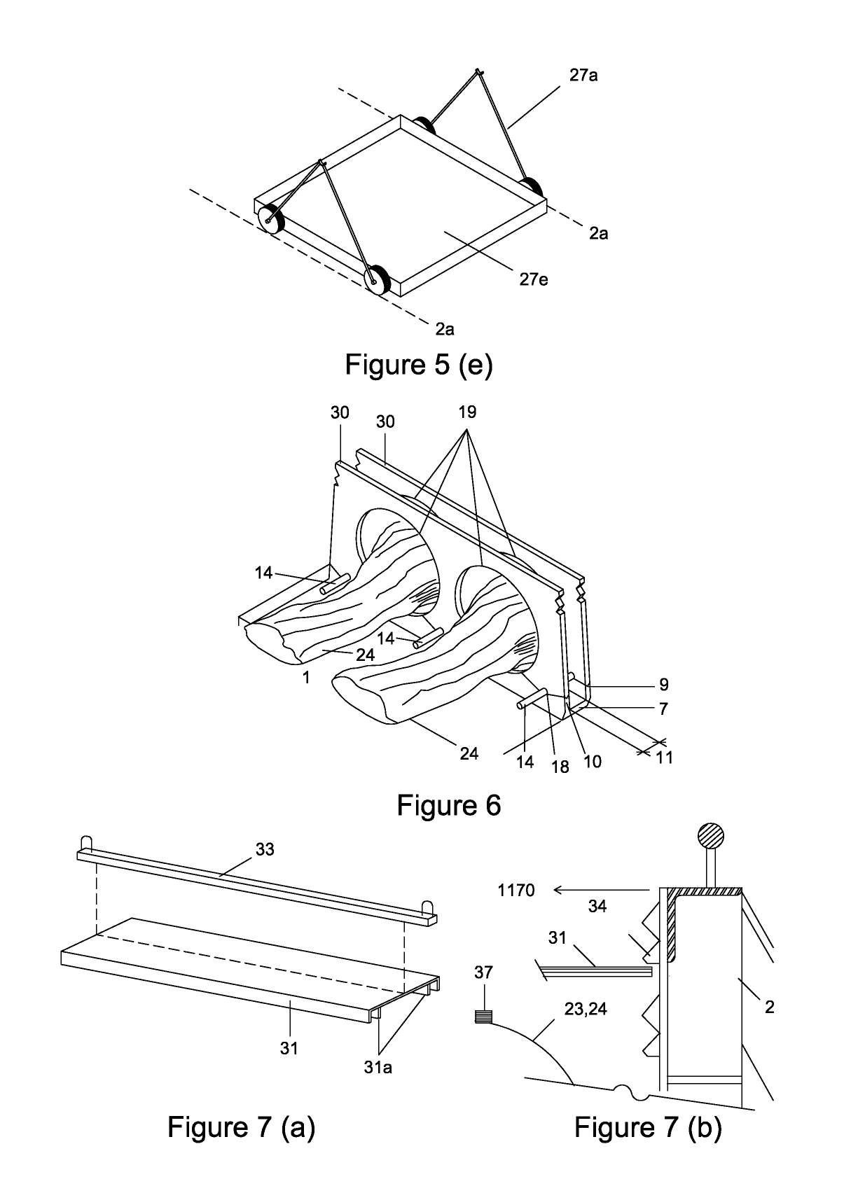

Shutters 2 along the full length of casting line 1 are now hinged inwards to their substantially vertical positions, as shown in FIG. 1(b). Core formers 23 encased in a sleeve 24, shown in FIG. 5(a), are now drawn by winching along the length of casting line 1. Core formers 23 are preferably made of a pliantly flexible woven or non-woven man-made or synthetic material, and for example, canvas can be considered suitable. Sleeves 24 are preferably made of a pliantly flexible polymer or plastics, such as a thin nylon or polyester. The core formers 23 are non-elastically expandable or substantially non-elastically expandable, and will undergo very little or no plastic deformation when in use. Preferably, the sleeves 24 are also similarly non-elastically expandable or substantially non-elastically expandable, and will undergo very little or no plastic deformation when in use. Like the core formers, the sleeves are also preferably pliantly flexible.

The sleeve 24 is always pulled or drawn along the casting line 1 from end 13 to end 8. One core former 23 and sleeve 24 is provided for each proposed core or void 19 of a particular hollowcore slab 3 to be cast. By way of example, FIG. 5(a) shows only two core formers 23 and sleeves 24 for a possible deep but narrow hollowcore slab 3. However, for a 250 mm deep hollowcore slab 3, five core formers 23 and sleeves 24 will be required to create five cores or voids 19.

Core formers 23 and sleeves 24 are laid over the bottom curved recesses 15 of base plates 7. Flexible guide unit 21 with walls 22 serve to retain core formers 23 and sleeves 24 within the boundary of their final inflated shape despite the fact that they are not, as yet, inflated. Without flexible guide unit 21, deflated core formers 23 and sleeves 24 would possibly spread horizontally and haphazardly over the stressed strand wires 14, making it difficult to insert the support shutter at each end of the individual hollowcore slabs 3 to be cast, which are at the outer faces of the dividers 9 and 10. For clarity, strand wires 14 are omitted in FIG. 5(a).

Continuous core former 23 and associated sleeve 24 can be made in lengths from 8 metres up to 200 metres. FIG. 1(a), FIG. 2(a) and FIG. 5(a) by way of example show casting line 1 which can be any length from 10 m up to 200 m.

There are three methods of winching along the core formers 23 and sleeves 24.

In the first method, an elongate flexible element, such as a connector 26, being in this case a rope, and around 2 to 4 meters longer than the full length of the particular core formers 23 and sleeves 24 to be pulled is attached to the end of each core former 23 and sleeve 24 via a lanyard 25. The operator then pulls connector 26 along casting line 1 which draws the attached core former 23 and sleeve 24 there behind until it reaches end 8, as seen in FIG. 5(b). The connector 26 is stacked in a coil 26(a) on the ground spaced from the casting line 1 or on the surface of casting line 1. This first method would be used when hollowcore slabs 3 are being made on a small site where possibly one or two short lengths, for example, 10 to 30 meters, of casting lines 1 are being used.

The second method involves the same connector 26 or other elongate flexible element, but instead of being loose, each connector 26 is initially wound around a separate reel fixed to central shaft 27 held by a carriage 27a resting on a plurality of wheels, for example, four, which in turn lies on each rail 2a across casting line 1, see FIGS. 5(c) and 5(a). For clarity, shutters 2 have been omitted in FIG. 5(a). Individual reels on shaft 27 are centred in line with each core former 23 and sleeve 24 of the particular slab section 20 and contain the ropes 26. The whole length of ropes 26 are wound onto the individual reels with the exception of the final 1 to 2 meters attached to the ends of core formers 23 and sleeves 24 at lanyard 25. Carriage 27a mounted on the continuous rails 2a acting as tracks, is now pulled along the longitudinal extent of casting line 1 by the operators with the core formers 23 and sleeves 24 trailing behind. Once carriage 27a has passed end 16, see FIG. 5(a), it is parked into place on frame supports 2b. This method would be used in hollowcore plants where labour is relatively cheap and there is a desire to limit as much as possible mechanical processes.

Beneficially, to enable the carriage 27a to be moved along the longitudinal extent of the casting line 1 by providing the carriage 27a with extended or outboard axles and either movable wheels or sets of inboard and outboard wheels, the closed and open conditions of the shutters 2 can be accommodated.

The third method again involves a similar shaft 27 and carriage 27a. However, in this case, the carriage 27a is pulled along rails 2a by a powered, such as electric, winch connected to carriage 27a with a rope or other suitable elongate flexible element, and located behind end 16. Ropes 26 unwind from shaft 27 whilst the core formers 23 and sleeves 24 remain stationary at end 13. Once carriage 27a is locked into place past end 16, ropes 26 are mechanically rewound onto shaft 27 at the same time pulling the core formers 23 and sleeves 24 along the casting line 1.

Carriage 27a remains on rail 2a on support frames 2b past end 16, see FIG. 5(a) and for example FIG. 5(d). Separating pin 26b on each connector 26 is positioned around 1 metre from the end of lanyard 25. The pin 26b provides a joint along the connector 26 and thus allows the majority of connector 26 to remain on its reel on shaft 27. The reel can then be temporarily placed in stock in a secure area away from casting line 1, once the pin 26b is released. This allows carriages 27a to be used as independent transport storage devices. For example, operators can load items onto the flat base 27e of carriage 27a and move carriage 27a along rails 2a down the length of casting line 1, depositing relevant items before or after the shutters 2 are locked into place ready for casting. FIG. 5(e) shows a perspective view of carriage 27a and the storage surface 27e. When all the individual items have been deposited at their correct positions, carriage 27a is brought back to its parking location at the end 16 in FIGS. 5(a) and 5(d).

The ends of core formers 23 and sleeves 24, at end 8 in FIG. 5(a), are locked onto an air valve 28 with inlet/shut off lever 28a to feed pressurised air from a low-pressure air system into the lengths of core formers 23. The other end of the core formers 23 at end 13, is sealed with a horizontal ring eye 29 protruding from its end. Core formers 23 are now partially inflated by compressed air supplied from a main air receiver 28b. A preferably metal planar upper divider 30 extends over the remaining depth of the slab section 20, see FIG. 6. Upper dividers 30 are mounted on the upper edge of dividers 9 and 10 so that together the depth matches the depth of slab section 20. The upper dividers 30 incorporate curved recesses which match the curved recesses 15 so as together to encircle the lateral extents of the core formers 23 and sleeves 24.

The base of upper divider 30 covers the protruding top semi circular section of the exposed bottom strand wires 14 nestling in locators 18. Upper divider 30 in FIG. 6 shows the method of encapsulating strand wires 14 between adjacent cores or voids 19. In this case a single strand wire 14 is shown between core or voids 19. In the event that two or more strand wires 14 are required to be laid adjacent to each other between core or void 19 then not only is base plate 7 designed to accommodate the multiple strand wires 14 but also upper divider 30.

Upper dividers 30 for making 150 or 200 mm deep hollowcore slabs 3 will have a wider top width as previously explained above. This will ensure that the sloping surface edges of the upper dividers 30 will have a tight sealed fit to the rigid sides of shutters 2.

A single metal u-shaped capping piece 31, shown in FIG. 7(a), is now placed over the top of each of the two upper dividers 30 resting on lower dividers 9, 10 along casting line 1 to protect the void area between the two inner faces of upper divider 30 across the gap 11, see FIG. 2, from concrete ingress. Internal strip anchors 31a, welded to the underside of capping piece 31, ensures the two upper dividers 30 are restrained vertically when concrete is poured against the end face of the hollowcore slab 3 being cast. Note: capping pieces 31 can be transported down the length of casting line 1 using the transport device carriage 27a.

Shutters 2 along the full line of casting line 1 are now anchored into place by, typically steel, supports 32, seen in FIG. 1(b), and locked across the top of each shutter 2. The supports 32 are preferably spaced apart by 2 meters down the full length of casting line 1 to resist the outward pressure of concrete against side shutters 2. Additional steel supports 33, seen in FIG. 7(a), are placed over the top of each capping piece 31 and also anchored on each shutter 2 to prevent capping pieces 31 and upper dividers 30 positioned on lower dividers 9, 10 from rising upwards during casting operations. Supports 33 are only used when the hollowcore slab 3 to be cast is 250 mm deep, as shown in FIG. 1(f), such that the tops of shutters 2 finish precisely at the top of the proposed hollowcore slab 3. If either a 200 or 150 mm hollowcore slab 3 is to be cast using 250 mm deep shutters 2, as shown in FIG. 1(f), there is no necessity for supports 33 to support capping pieces 31. FIG. 7(b) shows capping piece 31 placed over upper divider 30 for a 200 mm deep hollowcore slab 3. All capping pieces 31 preferably have a fixed overall length of 1170 mm whereby the ends of the capping pieces 31 will finish before the face of each shutter 2. The gap would increase marginally for a 150 mm deep hollowcore slab 3 as previously explained above. Horizontal indent 34 on shutters 2, some 5 mm above the top of the 200 mm or for example a 150 mm hollowcore slab 3, ensures that during the casting operation the upward pressure on the two adjacent upper dividers 30 under capping piece 31 are restrained by the locked sides of the shutters 2.

All core formers 23 are now fully inflated with the addition of more compressed air. Each valve 28, see FIG. 5(a), has a gauge 35 to verify that the correct air pressure in core formers 23 is achieved, typically being 0.75 to 7 bar depending on the type of material used for the fabrication of core formers 23. The diameter of sleeve 24 is the precise diameter of cores or voids 19, and the diameter of core formers 23 is marginally bigger than the diameter of 24, ensuring that when the core formers 23 are fully inflated the complete outer surfaces of the associated sleeves 24 are smooth and taut against the surface of core formers 23. Once inflated, core formers 23 and sleeves 24 will remain cantilevered out from and suspended between lower dividers 9 and 10, and ends 8 and 13.

Self-Compacting Concrete, hereinafter referred to as SCC and to this point which has not been usable with cast hollowcore slabs, is then merely poured into a complete mould so there is ample scope to insert many key features into a typical hollowcore slab 3 before casting. This therefore allows these features to be bonded, formed and provided in the concrete mix at the time of pouring, rather than traditionally post-pouring. For example all secondary reinforcement links, stirrups or mesh, anchoring devices, water pipes and conduits, and so forth to meet requisite specifications can be provided for at the time of pouring, and this has not been possible using traditional known methods. Shear reinforcement can very often be combined with mandatory reinforcement that has to be inserted into individual mould lengths so as to ensure that the stability of the core formers 23 and sleeves 24 is maintained at all times during the casting and curing phases of production.

At the ends of each hollowcore slab 3, strand wires 14 are rigidly anchored in place over the lengths of the hollowcore slabs 3, typically being of up to 7 to 8 metres. Strand wires 14 therefore can provide a strong tensile restraint that can be used to eliminate the uplift from the light weight core formers 23 and sleeves 24 during the concrete casting operation.

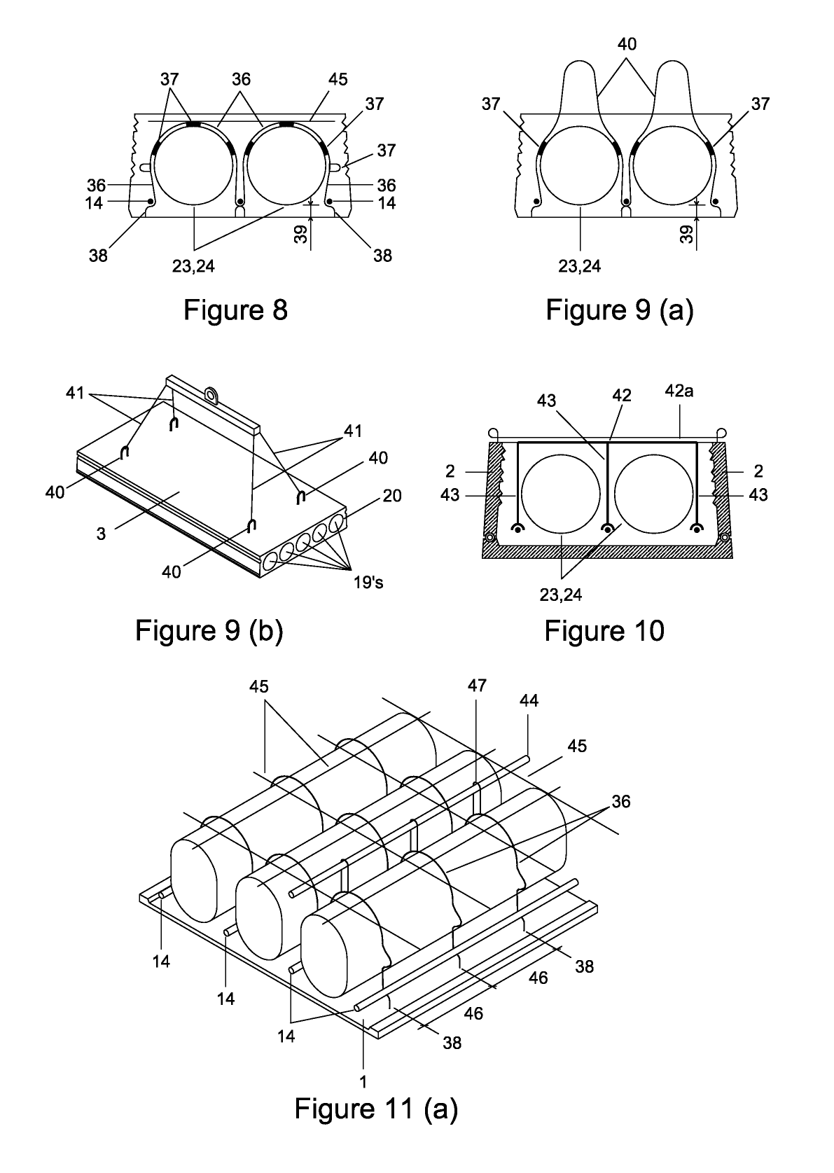

Consequently, specially bent or hooped reinforcing bar holders 36, seen in FIG. 8, can be anchored into place, at intermittent points over core formers 23 and sleeves 24. Hooped bars 36 are positioned some 10 to 15 mm from the surface of core formers 23 and sleeves 24, and hooked under lower strand wires 14. Concrete cover blocks 37 ensure the light weight core formers 23 and sleeves 24 do not move sideways or upwards by the force of the self compacting concrete entering the mould boxes formed on casting line 1. Cover blocks 37 also ensure hooped bars 36 are surrounded with concrete during pouring. Intermittently placed hooped bars 36 may have extended legs 38 resting on casting line 1 maintaining the correct spacing 39 of strand wires 14 over the full length of individual hollowcore slabs 3. Alternatively the base of the two legs 36 can be merely hooked under strand wires 14.

In each individual length of hollowcore slab 3 four hooped bars 36 will be adapted to incorporate extended loop 40, seen in FIG. 9(a), which will protrude from the top of the finished concrete surface of the complete cast hollowcore slab 3. Extended loops 40 are located at an appropriate distance away from the ends of each hollowcore slab 3, as shown in FIG. 9(b), to provide a fail-safe lifting system to anchor hooks for lifting chains or slings 41 to allow removal of completed hollowcore slabs 3 from casting line 1 to the stock yard or transport and subsequent installation on site.

For longer spans of hollowcore slabs 3 where the overall depth is above 300 mm it may be necessary to provide additional restraint to the strand wires 14 to limit their uplift. A, preferably steel, lateral anchor or lateral prong device 42, shown in FIG. 10, is inserted centrally between each base plate 7 of the long hollowcore slab 3 to be cast. Prong device 42 comprises of a rigid cross bar 42a, anchored to the top of each shutter 2 and which is attached to vertically depending bars 43. The depending bars 43 straddle the strand wires 14. The prong devices 42 prevent or limit up lift of the strand wires 14 because of the force imparted to the hooped bars 36 by the tendency of the core formers 23 and sleeves 24 to float. Whilst hooped bars 36, see FIG. 8, are retained in the finished hollowcore slab 3, prong devices 42 are removed immediately the concrete pouring operation is complete, because at that stage there will be no further upwards flotation force on core formers 23 and sleeves 24 since the whole surface area of core formers 23 and sleeves 24 will have more or less equal density of concrete around them.

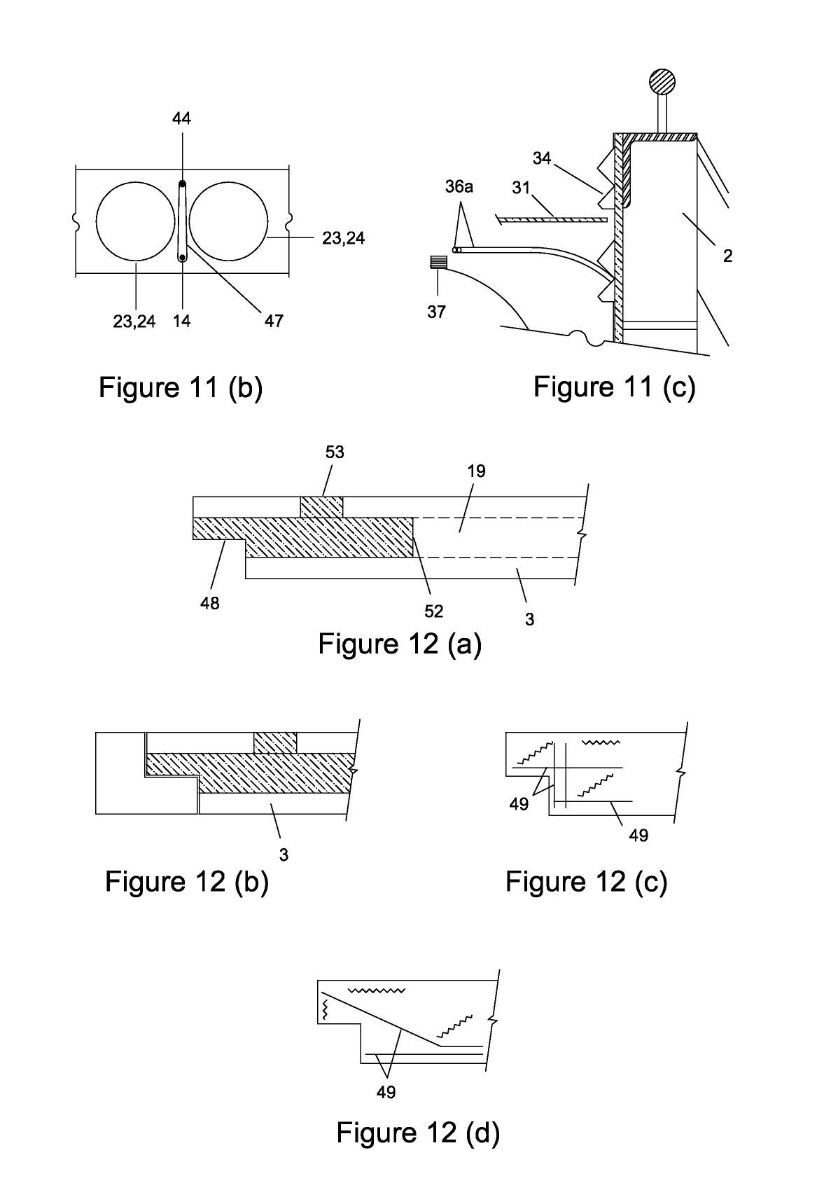

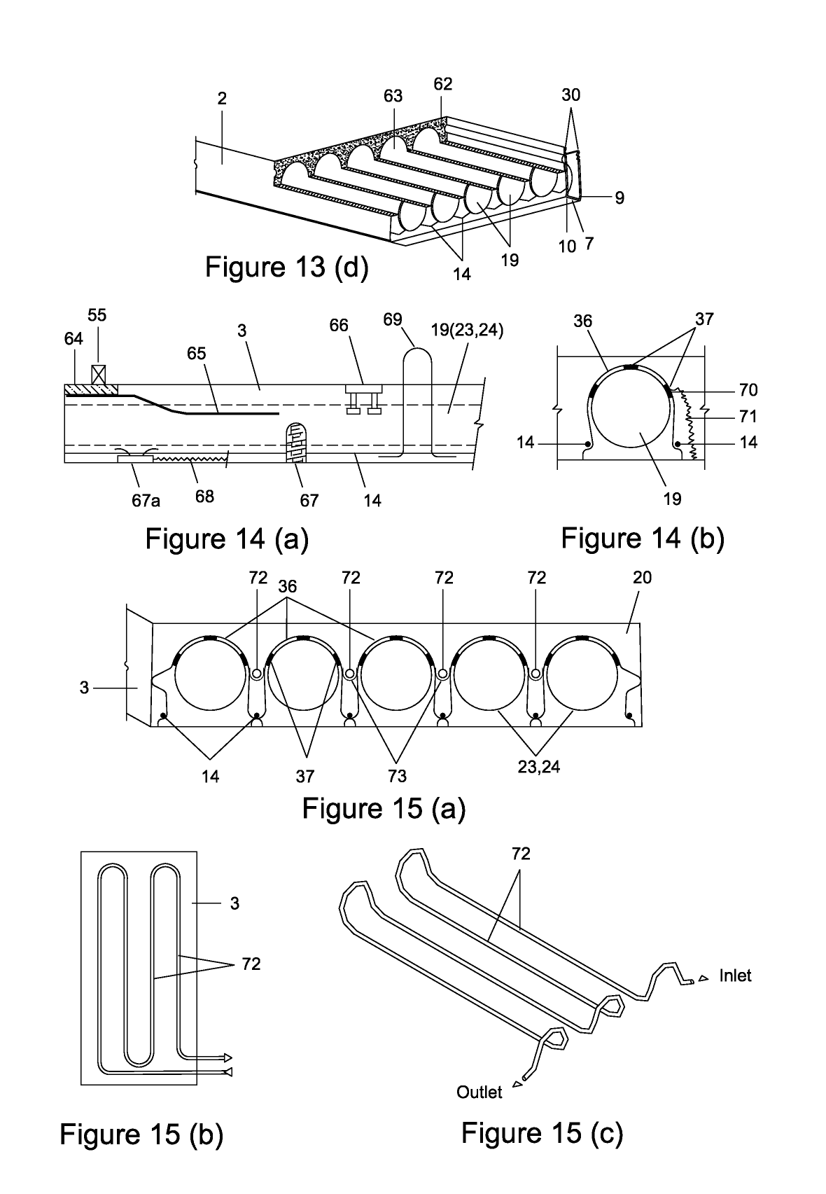

Heavily loaded and deep hollowcore slabs 3, for example, 340 mm depth and greater, can be constructed with additional shear reinforcement to create a truss action. Top reinforcement 44 could be used and a layer of, for example, steel, mesh 45, shown in FIG. 11(a) and FIG. 8, laid across top of hooped bars 36. Mesh 45 has been schematically elevated in FIG. 11(a) and shutters 2 removed for clarity. The distance 46 between individual cover blocks 37, shown in FIG. 13(a), can be adjusted according to design specifications. An additional link 47, shown in FIGS. 11(a) and 11(b) can also be provided around the top reinforced and bottom strand wires 14 as required.

There is an additional method of restraining uplift of the core formers 23 and sleeves 24 that could be used in certain situations.

Referring to FIG. 11(c), a horizontal reinforcing bar 36a of appropriate diameter with angled ends to fit into whichever indent 34 in the sides of shutters 2 ensures the underside of reinforcing bars 36a will be 10 to 15 mm above core formers 23 and sleeves 24 with cover blocks 37. Reinforcing bars 36a would preferably be in pairs, side by side, connected via tack welds or reinforcing tie wire. This will ensure they will not rotate once the upward force is applied via hooped bars 36 from the upward pressure against the core formers 23 and sleeves 24 during the casting operation.

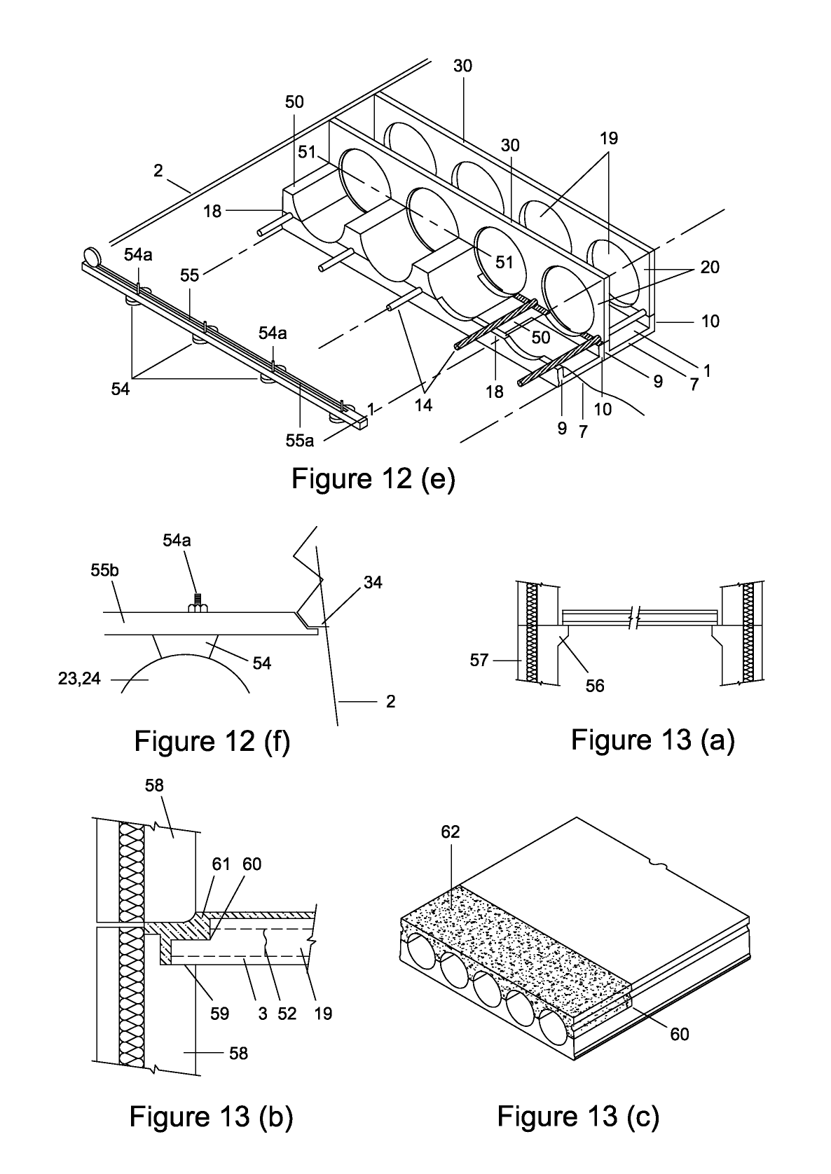

There is very often a requirement to insert additional reinforcement at the supporting end of a hollowcore slab 3 which is not possible with machinery cast hollowcore slabs 3a. FIG. 12(a) shows a sectional side view passing through a core or void 19 of the supporting end of a hollowcore slab 3 with a half jointed end 48 which allows the supporting beams to be shallower so hollowcore slab 3 does not have to sit on top of the beam. Furthermore the soffit of the beam supporting hollowcore slab 3, shown in FIG. 12(b), can now be flush with the soffit of hollowcore slab 3 providing a complete flat ceiling surface from wall to wall. In these instances significant ties are required to be cast directly into the two ends of hollowcore slab 3 providing the necessary structural robustness of the total structure. FIG. 12(c) and FIG. 12(d) show typical configurations of reinforcement 49 that can be inserted into the hollowcore mould prior to casting, thereby meeting the engineers' specifications.

To enhance the strength of concrete used for hollowcore slabs 3, it is also possible to add reinforcing, such as steel fibres into the concrete mix effectively introducing the equivalent of secondary reinforcement and dramatically increasing the shear capacity of a typical hollowcore slab 3. This allows for longer spans and higher impact loads, thus meeting specifications which would not be possible without such an additive. Steel or other kinds of fibres incorporated in the hollowcore slab mix would reduce and in some cases negate the requirements for additional reinforcement 49, as detailed in FIGS. 12(c) and 12(d). Mesh reinforcement 45 as shown in FIG. 11(a) could also be placed on top of the strand wires 14 near the bottom of the hollowcore slab 3 to provide increased structural capacity. Additionally or alternatively, one or more reinforcing bar elements could be included to promote or impart greater shear reinforcement.

Poly-fibres can also, additionally or alternatively, be added to mitigate a fire risk. During a fire, the poly fibres tend to melt, allowing for steam migration through the slab and thus preventing or limiting the risk of spalling.

Voided area 48 is created by placing an additional base plate 7 to be laid on casting line 1 immediately adjacent to the inner surface of the end of the proposed hollowcore slab 3 at upper divider 30, see FIG. 12(e). A polyurethane or similar material filler element 50, seen in FIG. 12(e), is then placed onto surface locators 18 of dividers 9 and 10 on the inner base plate 7. Filler element 50 finishes on the horizontal core centre line 51 of a hollowcore slab 3 to be cast. Different sized filler elements 50 can be made to accommodate all core formers 23 and sleeves 24 and configurations of strand wires 14 as previously detailed. For clarity, in FIG. 12(e), filler element 50 is only shown over three cores or voids 19.

Cores or voids 19, shown in FIG. 3 and FIG. 12(a), remaining when core formers 23 and sleeves 24 have been removed after casting, have to be filled with concrete some distance from half jointed end 48 to internal position 52, shown shaded in FIG. 12(a). To place concrete into voided area of cores or voids 19 back to internal position 52, it is necessary to create a feed hole 53 at the top of each vacant core or void 19. For 250 mm deep hollowcore slabs 3 only, using 250 mm deep side shutters 2, prior to casting, specially shaped block outs 54, shown in FIG. 12(e), are supported by a cross bar 55 locked into place on the top of each shutter 2. Cross bar 55 has a continuous slot 55a over its length to enable block outs 54 to be anchored with a nut screwed onto a protruding threaded bar 54a from the top of block outs 54 passing through cross bar 55a. Bearing locations of block outs 54 according to different slab sections 20 and the number of core formers 23 and sleeves 24 allows block outs 54 to be locked at any point along cross bar 55. The top surfaces of core formers 23 and sleeves 24, during their final inflation, press tightly to the underside of block outs 54 which have a radiused concave soffit to match the radius of the outer surfaces of the core formers 23 and sleeves 24. This ensures no concrete laitance can encroach onto the inner surface of block outs 54. After casting, cross bar 55 and block outs 54 are removed leaving the voided area feed hole 53, shown in FIG. 12(a). This allows the insertion of concrete mix to fill up the voided area to the internal position 52. If either a 200 or 150 mm hollowcore slab 3 is to be cast using 250 mm deep shutters 2, as shown in FIG. 1(f), block outs 54 of the appropriate size would be locked into a commonly adapted cross bar 55b, see FIG. 12(f). The ends of cross bar 55b being wedged under indent 34 on each side of shutters 2.

The support required for all hollowcore slabs 3, from both ends, is typically around 10 cm and is generally the top of a beam or, if only a wall is available, on a corbel extending from the face of the wall. There are very often aesthetic reasons to try to eliminate the unsightly beam below hollowcore slab 3 as achieved in FIG. 12(b), or corbel protruding from a wall. FIG. 13(a) shows a typical supporting corbel 56 cast into a load bearing external wall 57. FIG. 13(b) shows the method using the hollowcore technology of the invention to eliminate corbel 56 and thereby create a flat ceiling from notched wall 58. Notched wall 58 becomes the support wall for hollowcore slab 3 and is installed and propped on site. Hollowcore slab 3 is then laid onto the horizontal return 59 of notched wall 58. The supporting end of hollowcore slab 3 has been treated such that from the centre of the overall depth of hollowcore slab 3 the remaining concrete is removed up to the top of hollowcore slab 3 at a 90 degree angle, or equally effective would be a radiused arc 60 creating a continuous void across the full width of hollowcore slab 3. Reinforcement followed by concrete to connect hollowcore slab 3 with notched wall 58 is then inserted into void area 61, which is shown shaded. Individual cores or voids 19 are plugged back to internal position 52. Void area 61 creates a strong structural connection between hollowcore slab 3 and notched wall 58 thus dispensing with the need for support corbel 56. The installation of notched wall 58 proceeds for the next wall above hollowcore slab 3, once the concrete in void area 61 has reached its design strength.

The voided area 60 at the end of hollowcore slab 3 is formed around the inflated core formers 23 and sleeves 24 before casting of hollowcore slab 3. However, with traditional machinery-made hollowcore slabs 3a, the voided area can only be removed after the casting operation, thus involving removal and disposal of the concrete mix. FIG. 13(c) shows a soft polyurethane or similar material blank 62 which is used to ‘block out’ void area 61. Blank 62 is cast as a one-piece unitary element and is adapted to cover the whole top surface of the hollowcore slab 3. The recesses 63 on the underside of blank 62, shown in FIG. 13(d), are shaped to accommodate the semi circular top half of all core formers 23 and sleeves 24. Different sized blanks 62 can be made to suit the particular slab section 20 and the number and diameter of the proposed cores or voids 19. The diameter of the shaped semicircular recesses 63 to accommodate core formers 23 and sleeves 24 would be some 2 to 3 mm less than the fully inflated diameter of the core formers 23 and sleeves 24 ensuring no leakage of laitance underneath blank 62 or through recesses 63 during the casting operation.

Connections and fittings for a variety of purposes, for example, surface plates with embedded anchoring reinforcement, threaded sockets, conduits, sensors, lifting loops and water pipes can easily be cast into the hollowcore slab 3 during the new casting process, as shown in side elevation FIG. 14(a) of a typical hollowcore slabs 3. Core or void 19 is shown as dotted lines. All connections and fittings are fixed as required into the mould area before casting the concrete. Thus, surface plate 64 with a welded ancillary reinforcing bar 65 for bonding can be located anywhere on the top surface or soffit of the proposed hollowcore slabs 3. Reinforcing bar 65 is shown below the top of core or void 19 because in this case it rests in the webs between adjacent core formers 23 and sleeves 24. If located on the top of hollowcore slab 3 as shown, surface plate 64 is supported by cross bar 55 which is anchored to shutters 2 on each side of casting line 1, similar to cross bar 55 shown in FIG. 12(e). If surface plate 64 is required to be cast in the soffit of hollowcore slab 3, it can be located onto the surface of casting line 1 by tap welding, surface glue or magnetic attachment. Surface plate 66 has shear studs welded underneath and can also be anchored in a similar way to surface plate 64. Threaded sockets 67 can likewise be anchored to the top or bottom surface, again in the same manner as surface plate 64. Socket 67, because of its length as shown in FIG. 14(a), can only be anchored in the webs between the cores or voids cores or voids 19. A smaller threaded length of socket would be necessary when anchoring over or under a core or void 19 to avoid interfering with core formers 23 and sleeve 24 before the casting operation is complete.

Electrical conduit boxes 67a and cable 68 can also be located on any of the surface or soffit area and boxes 67a and cable 68 can be inserted to cross the width of hollowcore slab 3 before casting of the concrete. With traditional machinery-produced hollowcore slabs 3a, it is only possible to lay boxes and cables down the inside of the cores or voids 19 lengthwise. Boxes 67a and cables 68 also have to be exposed on the soffit in the event of wanting to cross between cores or voids 19, leading to unsightly clutter on the smooth soffit surface of hollowcore slabs 3a.

It is also possible to use a simplified alternative method of fixing lifting loops 40 as previously described with reference to FIGS. 9(a) and 9(b). Further lifting loop 69, shown in FIG. 14(a), represents a typical lifting loop at 90 degrees to the loop 40 shown in FIG. 9(a). Lifting loop 69 is anchored in the web between adjacent cores or voids 19 and tied to the strand wires 14 whereas lifting loop 40 fulfils a dual role of not only being able to provide the lifting point for lifting chains 41, see FIG. 9(b), but also of retaining core formers 23 and sleeves 24 via adapted hooped bars 36, see FIG. 8.

FIG. 14(b) shows a part section through FIG. 14(a). Sensor 70 may be locked into a cover block 37 to monitor the humidity of the air and the temperature of the concrete around cores or voids 19. Electrical feed 71 from the sensor 70 is cast into the hollowcore slab 3 and exits at a defined point to be connected to a building management system, a specific requirement for a TermoDeck® building where hollowcore slab 3 is used as a thermal mass energy store. Electrical feed 71 cannot be cast into traditional machinery-made hollowcore slabs 3a.

A primary energy transfer source of hot or cold water, pumped through small diameter pipes cast into a solid concrete floor, allows concrete to be the secondary energy transfer medium providing radiant heating or cooling in a building. The system, known as Thermocast®, can now be utilised in hollowcore slabs 3 instead of solid concrete, reducing capital costs and overall self-weight of the finished floor.

TermoDeck® is another means of providing radiant heating or cooling in a building. However, air is used instead of water as the primary energy transfer medium. Treated air is passed into and out of the hollowcore slabs 3, on the one hand reducing the amount of concrete and self-weight of hollowcore slab 3 and on the other conveniently using large size cores or voids 19 in a typical slab section 20. Hollowcore slab 3 becomes the secondary energy transfer medium and as the air leaves hollowcore slab 3 it beneficially also ventilates the room.

Hot or cold water pipes in the Thermocast® process have the advantage over TermoDeck® of being able to rapidly change the slab temperature, and therefore room temperature, to suit demand. The major disadvantage however is that Thermocast®, lacks any means of providing ventilation. In a Thermocast® building the capital and maintenance costs substantially increase to accommodate two independent systems, being water heating and cooling on the one hand and a ventilation system on the other.

Using the new hollowcore technology, TermoDeck® and Thermocast® can be combined in one hollowcore slab section. This has major advantages. On the one hand, a more rapid response time for temperature change requirements in a room are possible and on the other adequate and economical ventilation can be provided for the occupants. A series of interconnected small diameter water pipes can be inserted into an individual hollowcore slab mould prior to casting, which to date has not been possible with traditional techniques. Large diameter core formers 23 and sleeves 24, which can be selected from amongst a plurality of core formers of different sizes to suit not only the span load requirements of the particular hollowcore slab 3 but also the required volume of air for adequate ventilation in the room below, are also inserted as previously described.

FIG. 15(a) shows the principle of combining small diameter water pipes 72 with core formers 23 and sleeves 24 of a diameter to suit the energy and ventilation volume demand for a particular room. The water pipes 72 could also be located in the top or bottom halves of a typical slab section 20. Water pipes 72 are interconnected with one inlet and one outlet for each hollowcore slab 3 shown by way of example in plan view FIG. 15(b).

A set of water pipes 72 are individually installed in each proposed length of hollowcore slab 3. In FIG. 15(a), preferably steel, support u-bars 73 are locked into cover block 37, shown in FIG. 8, to provide support as necessary. In the mode shown in FIG. 15(a), water pipes 72 are placed into the mould on casting line 1 prior to concreting and tied to the support bars 73. Water pipe 72 is arched over core formers 23 and 24 to interconnect to the next water pipe 72, see FIG. 15(c). The inlet and outlet of the water pipes 72 can be either from the side or the top or bottom of hollowcore slabs 3. Whilst it is not possible to pass water pipes 72 through the shutters 2 or casting line 1, water pipes 72 can be fixed to either surface and plugged for later access.

Whilst FIG. 15(a) shows the interrelationship between the water pipes 72 and core formers 23 and sleeves 24, it is entirely possible to vary the configuration, not only with a different quantity of water pipes 72 but also core formers 23 and sleeves 24 which could also be of a smaller diameter. The changes may create a greater thermal capacity in the individual hollowcore slabs 3.

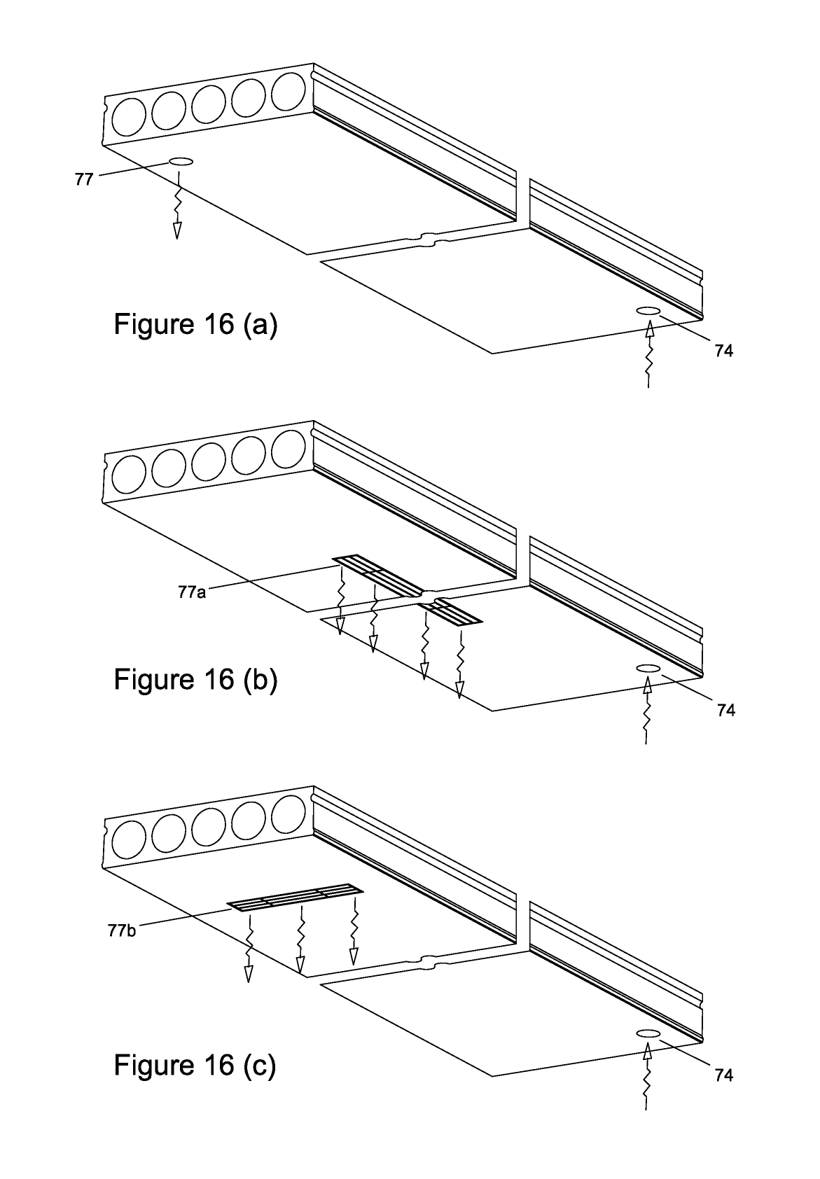

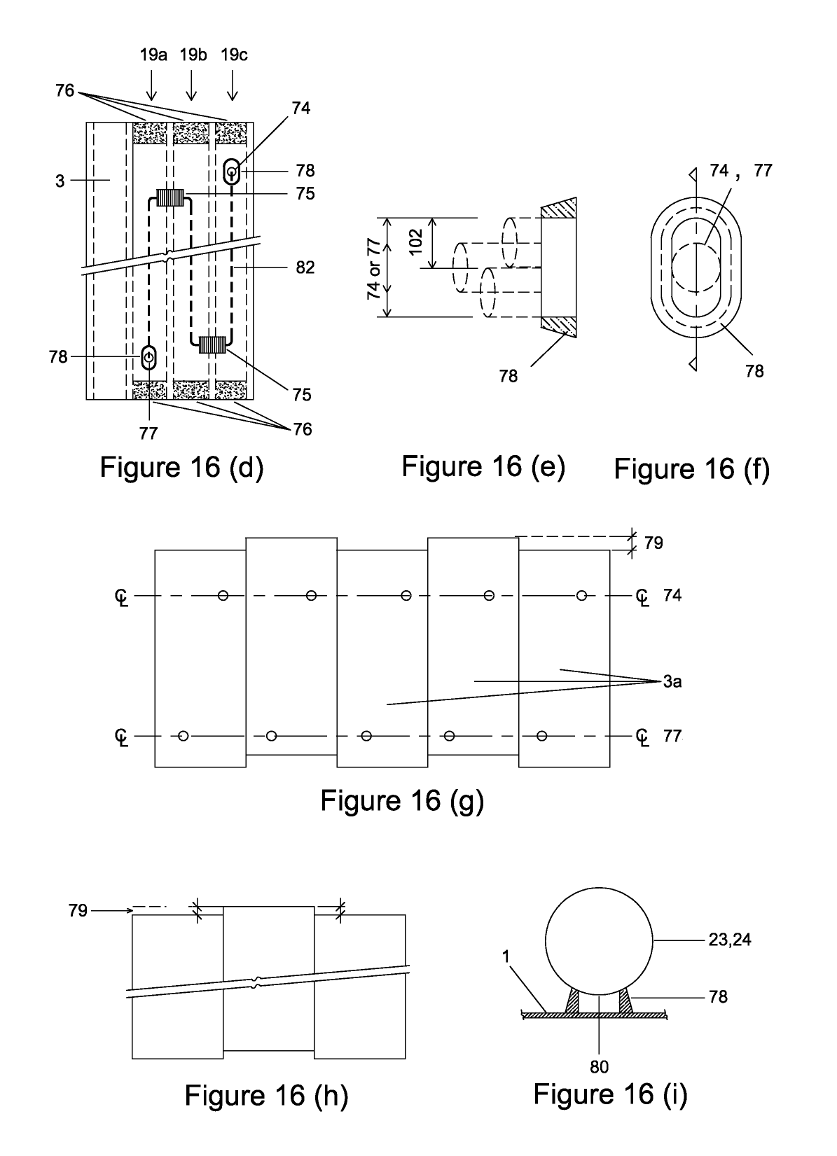

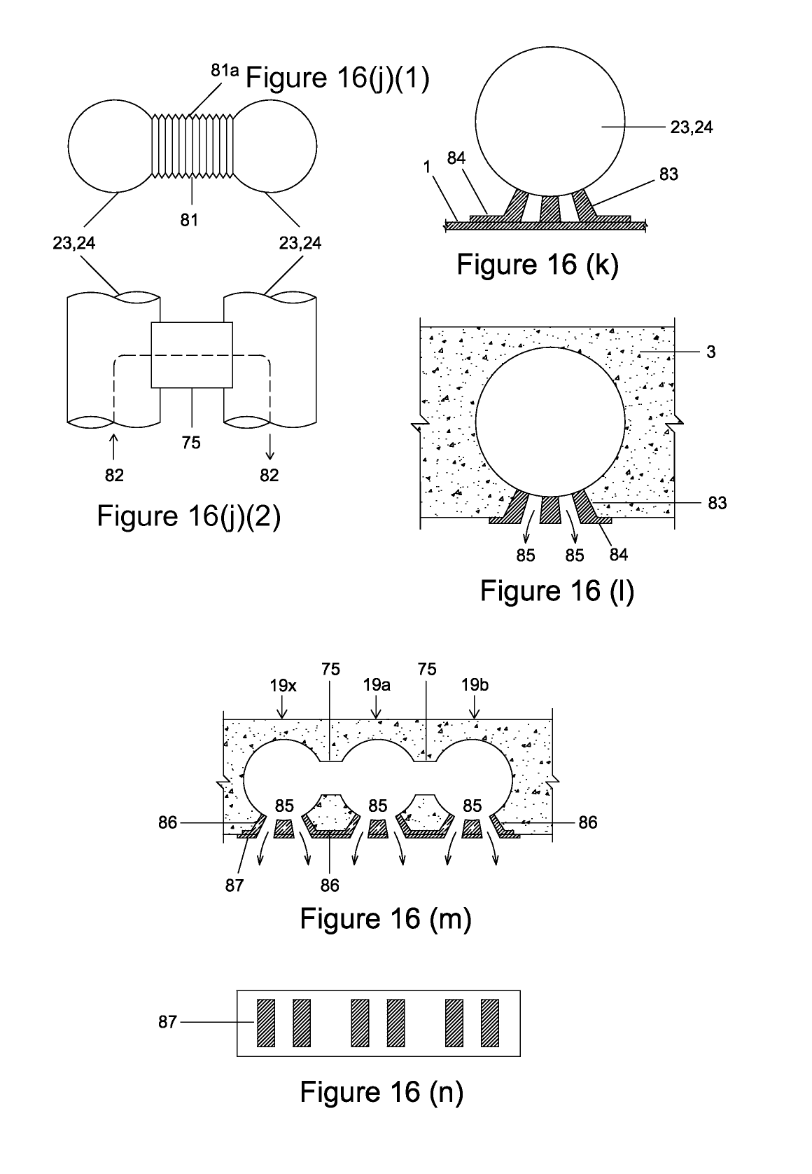

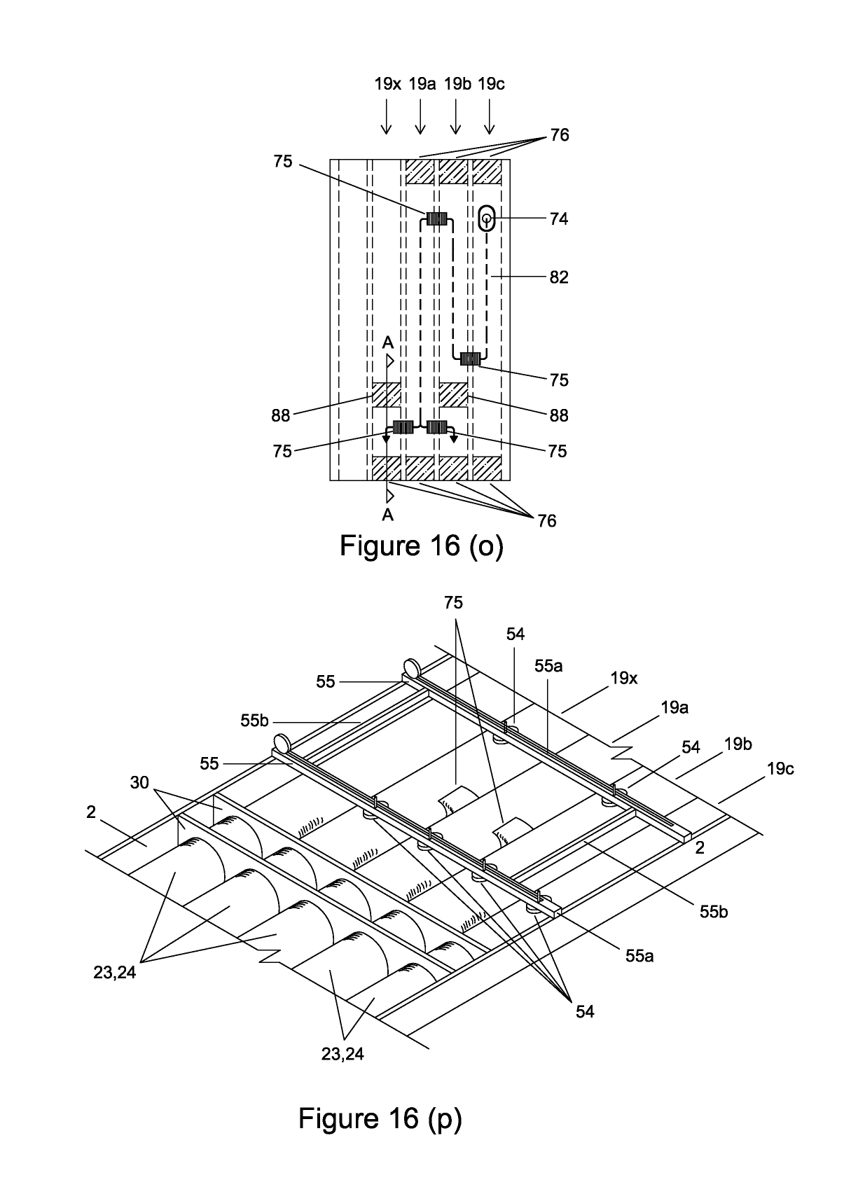

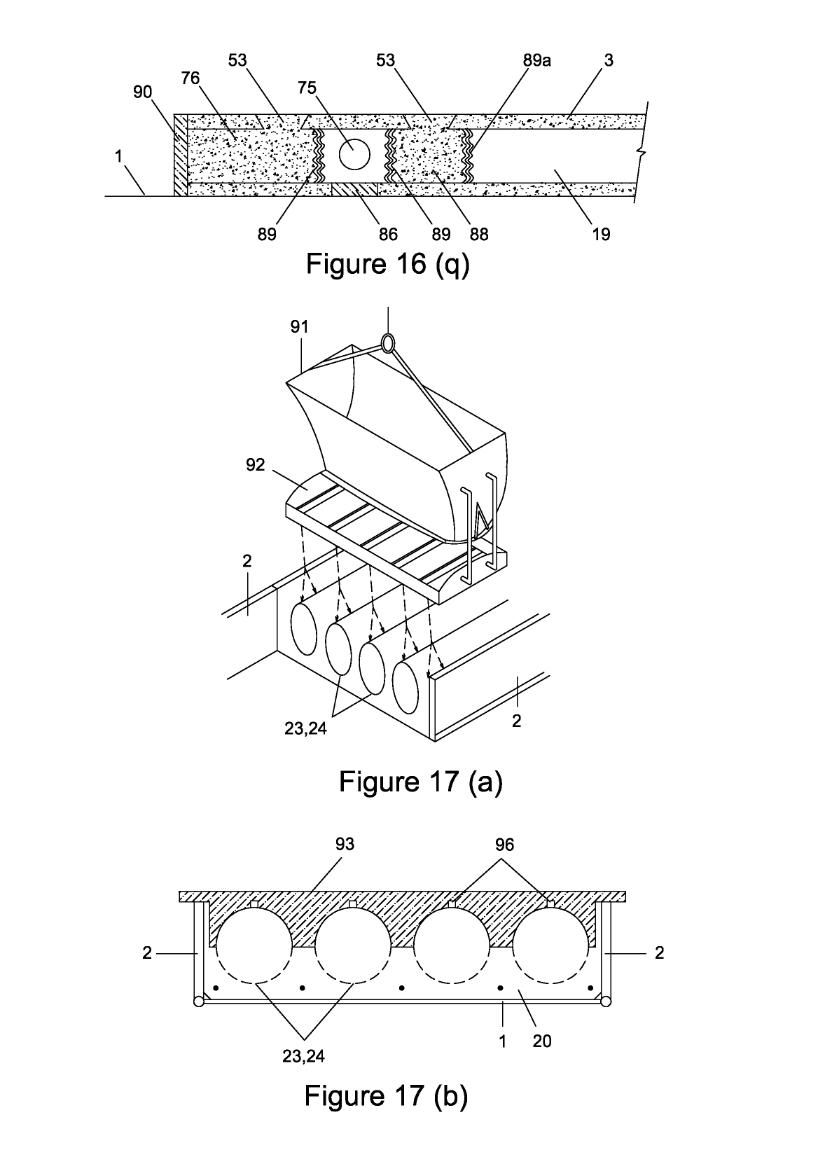

To allow air to pass into and out of the soffit or top surface of a TermoDeck® hollowcore slab 3, in FIG. 16(a), inlets 74 and outlets 77 can be specifically created at the pre-production stage obviating the necessity of employing complex and time-consuming on-site core drilling and cleaning apparatus when the hollowcore slabs are installed in place on site which is mandatory for machine-made hollowcore slabs 3a. The new hollowcore technology also allows for flush fitting, square or varied length linear outlets/diffusers 77a (FIG. 16(b) to be installed in the soffit or upper surface of the hollowcore slab 3, either longitudinally, or at 90 degrees to the line of the core or voids 19, see linear outlets/diffusers 77b in FIG. 16(c). This gives architects additional aesthetic opportunities to suit the interior design of a room without having to constantly resort to round diffuser outlets protruding below the soffit of the hollowcore slab 3.

FIG. 16(d) shows a typical plan view of a hollowcore slab 3 with three cores or voids 19 marked 19a, 19b and 19c. Inlet 74 provides an entrance into core or void 19c, and it is necessary to provide a cross connection feed 75 from core or void 19c to core void 19b and a further cross connection 75 to core void 19a. This allows the air to pass uninterrupted through the three cores or voids 19a, 19b and 19c, finally exiting from the hollowcore slab 3 at outlet 77 in core void 19a into the room below or above.

It is also essential in all individual TermoDeck® hollowcore slabs 3 that the air passing into and out of the hollowcore slab 3 via inlet 74 and outlet 77 does not leak at either end of the core or void 19a, 19b or 19c FIG. 16(d). This is made possible by securely sealing both ends of each of the three cores or voids by filling the ends with a concrete plug 76. The process has to be carried out after the individual hollowcore slabs 3 have been cast and remains on casting bed 1 with the core formers 23 and sleeves 24 removed, to be described hereinafter.

The installation for linear outlets 77a and 77b (FIGS. 16(b) and 16(c)) will be different from the installation of round outlets 77, FIG. 16(a), and round inlets 74 in FIGS. 16(a), 16(b) and 16(c). To install round outlets or inlets a typical TermoDeck® hollowcore slab 3 is identified during the setting out of the base plates 7. The construction drawing detailing the TermoDeck® hollowcore slab 3 will also provide the precise locations for inlets 74, cross-connection feeds 75 and outlets 77. A, preferably magnetic, oval plug 78 tapered at its sides as shown in FIG. 16(e) cross section and FIG. 16(f) plan view, is located where inlets 74 and outlets 77 are required. The length of the oval is in line with the length of core or void 19c and core or void 19a.

An inlet air supply duct is attached to the opening inlet 74 and is conventionally inserted after the hollowcore slab 3a has been installed on-site. The holes to be drilled at location inlet 74 are initially set out by the on-site core drilling crew ensuring that along a continuous line of adjacent hollowcore slabs 3a all the centre lines of inlets 74 will be in the same plane. FIG. 16(g) shows a typical reflected ceiling view. However with the new hollowcore technology of the present invention, all inlets 74, cross-connection feeds 75, and outlets 77 are inserted during the production process at precisely the designed location. It is extremely difficult however to accurately place each hollowcore slab 3 precisely into its designed location because of its weight, being typically between 1.5 and 10 tonnes on the one hand, and the free movement of hollowcore slab 3 as it hangs by the support rope from the crane on the other. Inevitably therefore hollowcore slabs 3 would be set out in a similar way to that shown in FIGS. 16(g) and 16(h), where errors 79 of the ends of adjacent hollowcore slabs 3 can be up to plus/minus 10 mm.

The errors 79 are therefore replicated with the centres of inlet 74 and outlet 77 in each hollowcore slab 3. MEP on site staff would therefore not be able to fix a continuous straight line of inlets 74 and outlets 77. However by using an oval opener plug 78 any dimensional errors on the setting out of individual hollowcore slabs 3 can be adjusted by moving the inlet air supply duct inlet 74 and outlet 77 by plus or minus 10 to 20 mm in either direction along cores or voids 19a and 19c. This ensures a continuous straight line of inlets 74 and outlets 77 is created in a series of adjacent hollowcore slabs 3, despite the possible positional error of the hollowcore slabs 3. Sectional elevation in FIG. 16(e) shows the possible maximum and minimum variation of the position of the inlet or outlet air supply ducts. The voided area remaining would be covered with a capping piece surrounding the inlet or outlet and fixed to the underside opener plug 78. Note that the location of the cross-connection feeds 75, set back from the ends of hollowcore slab 3, is not critical since they are internally created inside hollowcore slab 3 and errors of 10 to 100 mm make little difference to the performance of TermoDeck®.

FIG. 16(d) shows by way of example two openings, being air supply inlet 74 and air outlet 77. A special proprietary diffuser may be inserted into the outlet 77 once the hollowcore slabs 3 have been installed on-site. Once again, opener inlet 78 for the diffuser is preferably oval and the width of opener 78 suits the design width of the diffuser. Top surface 80, shown in FIG. 16(i), is radiused in a concave shape such that when core former 23 and sleeve 24 is fully inflated top surface 80 is pressurised against sleeve 24 ensuring that no laitance can come between the top surface 80 and sleeve 24. Once the hollowcore slab 3 has been cast and core formers 23 and sleeves 24 removed, when hollowcore slab 3 is lifted from casting line 1, opener plug 78 remains either locked onto the casting line 1 magnetically or it is wedged into the soffit of hollowcore slab 3. In this case opener 78 can then be removed by prising it from hollowcore slab 3 in the stock area leaving a precise opening for duct connection and such like. Thereafter standard round diffusers are inserted into the outlet 77 and the supply air duct connected to the round inlet duct 74 as normal

FIG. 16(j)(1) shows a plan view and FIG. 16(j)(2) shows a sectional cross section of cross-connection feeds 75 between core or void 19a and core or void 19b. A similar cross section also applies to core or void 19b and core or void 19c. Cross-connection feed 75 is formed by a specially moulded cementitious or similar material 81 having a diameter considerably less than the diameter of the two adjacent cores or voids 19 but with ends the same radius as the two cores or voids 19. Material 81 could also be manufactured out of aluminium ducts, by way of example, with serrated concertinaed edges 81a. The turbulence of air as it passes through one core or void 19a to a second core or void 19b via edges 81a is increased by the serrations, in turn accelerating the thermal transfer of energy to the hollowcore slabs 3. With conventional core drilling of cross connections only a smooth surface on the concrete surface of hollowcore slab 3a is achieved reducing the lead time for the equivalent thermal energy transfer. Material 81 is inserted at a similar location as shown on FIG. 16(d) and held between the two core formers 23 and sleeves 24 as they are inflated. Once fully inflated material 81 will be wedged between the adjacent sleeves 24 such that no laitance from the concrete pouring process can leak between the surface of sleeve 24 into the open ends of material 81. When the core formers 23 and sleeves 24 are deflated and removed the voided area of cross-connection feed 75 is created by the permanent material 81 remaining in place allowing uninterrupted air to pass from core or void 19a to core or void 19b and from core or void 19b to core or void 19c. Dotted line 82 in FIG. 16(d) shows the air pathway from inlet 74 to outlet 77.

To install linear outlets 77a and 77b, see FIGS. 16(b) and 16(c), once again a typical TermoDeck® hollowcore slab 3 is identified during the setting out of base plates 7, and once again the construction drawing will identify the proposed location of the inlet 74, cross connections 75 and linear outlets 77a or 77b. Linear outlets/diffusers 77a can vary in length from 60 mm up to 2000 mm depending on the supply air demand required. Linear outlets/diffusers 77a may be located in the third core or void 19 away from the inlet 74 similar to the configuration in FIG. 16(d) ie 19a.

FIG. 16(k) shows a cross section of a typical magnetised linear outlet/diffuser 83 anchored to casting bed 1 beneath core former 23 and sleeve 24. Whilst for round outlets 77 the oval opener 78 is removed before installation of the outlet 77 the linear diffuser 83 can be cast directly into the hollowcore slab 3. The bottom flange 84 would therefore be flush with the soffit 1 of the hollowcore slab 3. Equally a void for linear outlet/diffuser 83 can be created by a temporary magnetised opener similar to oval plug 78 and linear diffuser 83 inserted on site once hollowcore slab 3 has been installed. In this case the flange 84 for the linear diffuser 83 is exposed from the soffit of the hollowcore slab 3, FIG. 16(1). The top surface of linear diffuser 83 is radiused similar to top surface 80 in FIG. 16(i). Linear diffuser 83 consists of two linear air outlets 85 but there could equally be only one outlet 85 or multiples, three to four for example, depending on the supply air demand.

The installation of linear diffuser 77b, FIG. 16(c), requires substantial additional adaptation to the hollowcore slab 3. This is largely to ensure the strand wires 14 are not interrupted by the cross air flow on the one hand but also to maintain the essential concrete cover on the other, ensuring regional fire regulations are complied with at all times. FIG. 16(m) shows a cross section view through three number core formers 23 and sleeves 24. For clarity each of the core formers 23 and sleeves 24 are referred to as 19x, 19a and 19b similar to FIG. 16(d) except in this example the hollowcore slab 3 consists of five number core formers 23 and sleeves 24 (see plan view FIG. 16(o)). Additionally a fourth core former 23 and sleeve 24 19x is used to create the linear/diffuser outlet 77b. This ensures the rectangular linear outlet/diffuser 77b is centralised over the width of the hollowcore slab 3 for aesthetic purposes. Beneath each core former 23 and sleeve 24 in FIG. 16(m) a special outlet/diffuser 86 is inserted and is once again magnetised to the surface of casting bed 1 and held securely by the core formers 23 and sleeves 24 by the radiused top surface as previously described.

Cover plate 87 which once again can be magnetised is placed over the three number outlets/diffusers 86 to provide an aesthetic view when looking up from the floor below of the linear outlet diffuser 77b, as shown in FIG. 16(n). To create the linear distribution of air from the final core or void 19a the air is distributed to each adjacent core or void respectively 19x and 19b. This is achieved by incorporating a similar cross section feed 75 as shown in FIG. 16(d). As previously described the two number cross connections 75 would be retained by the core formers 23 and sleeves 24 during the casting process.

Once the core formers 23 and sleeves 24 are removed and the hollowcore slab 3 removed and installed on site the airflow will be directed downwards through each of the three number outlets/diffusers 85 through the three cores or voids 19. However it is important that the supply air entering core or void 19x and 19b is restricted from moving down the length of the two core voids and instead redirected downwards through the outlets/diffusers 86. It is therefore necessary to introduce an additional concrete plug 88 into each of the two cores or voids 19x and 19b, FIG. 16(o). The ends of each of the cores or voids 19x, 19a and 19b and 19c also have to be sealed by plugging the concrete 76 as previously described. Concrete plugs 88 and 76 can only be carried out after the individual hollowcore slab 3 has been cast and remains on casting bed 1 with the core formers 23 and sleeves 24 removed. Alternatively the operation can be carried out in the stockyard or on the site where the hollow core slab 3 has been installed. However before the casting operation it is necessary to create a feed hole 53 into the top of the core or voids 19x, 19a, 19b and 19c (see FIG. 12a). This will reduce operatives workload and the build up of detritus during the casting process by not having to cut away concrete for the required opening. FIG. 16(p) shows two independent cross bars 55 or a special frame 55b connecting the two 55s with a continuous slot 55a similar to that depicted in FIG. 12(e) spanning across each of the two side shutters 2 and to retain special block outs 54 which can be locked at any point along the cross bar 55 over the relevant core formers 23 and sleeves 24 as previously described. FIG. 16(p) shows two block outs 54 located over core formers 23 and sleeves 24 for the proposed blocking of core void 19x and 19b. An additional four block outs 54 are also required over the top of each core void 19x, 19a, 19b and 19c to enable the ends of the cores or voids of the hollow core slab 3 to be sealed. Once the casting operation has been completed and core formers 23 and sleeves 24 removed the additional concrete plugging operation can proceed. FIG. 16(q) shows a longitudinal cross section along line A-A through cast core void 19x for example with core formers 23 and sleeves 24 removed. The feed holes 53, similar to FIG. 12(a), are now used to enable a factory operator to insert end baffle 89 either side of the opening created by cross connection feed 75, with the additional baffle 89a for the opening and stop end for plug 88 to direct the supply air through the linear outlet/diffuser 86. Baffles 89 and 89a can be made out of polystyrene, foam block or cardboard filler, cut to shape and wedged in place. With baffles in place on all active cores or voids as well as baffles to seal the ends of cores or voids it only remains for a temporary shutter 90 to be placed over the end of the cast hollowcore slab 3 to retain the flowing concrete whilst plugs 76 and 88 are filled and permanently sealed.

When all additional reinforcement, anchors and such like have been appropriately positioned into the individual mould lengths of hollowcore slabs 3 and finally rechecked, concrete is poured into all the moulds down the whole length of casting line 1. It should be noted that all items that have been inserted in the individual mould lengths of hollowcore slab 3 can be transported to their relevant locations with the storage trolley carriage 27a as previously described. SCC can be delivered via ready mix concrete truck or by overhead crane containing a feed skip in an independent factory. Generally, in dedicated factories the concrete would be batched in the factory batching plant. For a very small quantity of hollowcore slabs 3 to be made on a short length of casting line 1 a separate on-site batch plant could deliver the mix. In all cases, the mix is directed to fall into the mould between the core formers 23 and sleeves 24, thereby filling up the mould area from the surface of casting line 1 upwards. SCC will flow easily around the strand wires 14 and the inflated core formers 23 and sleeves 24.

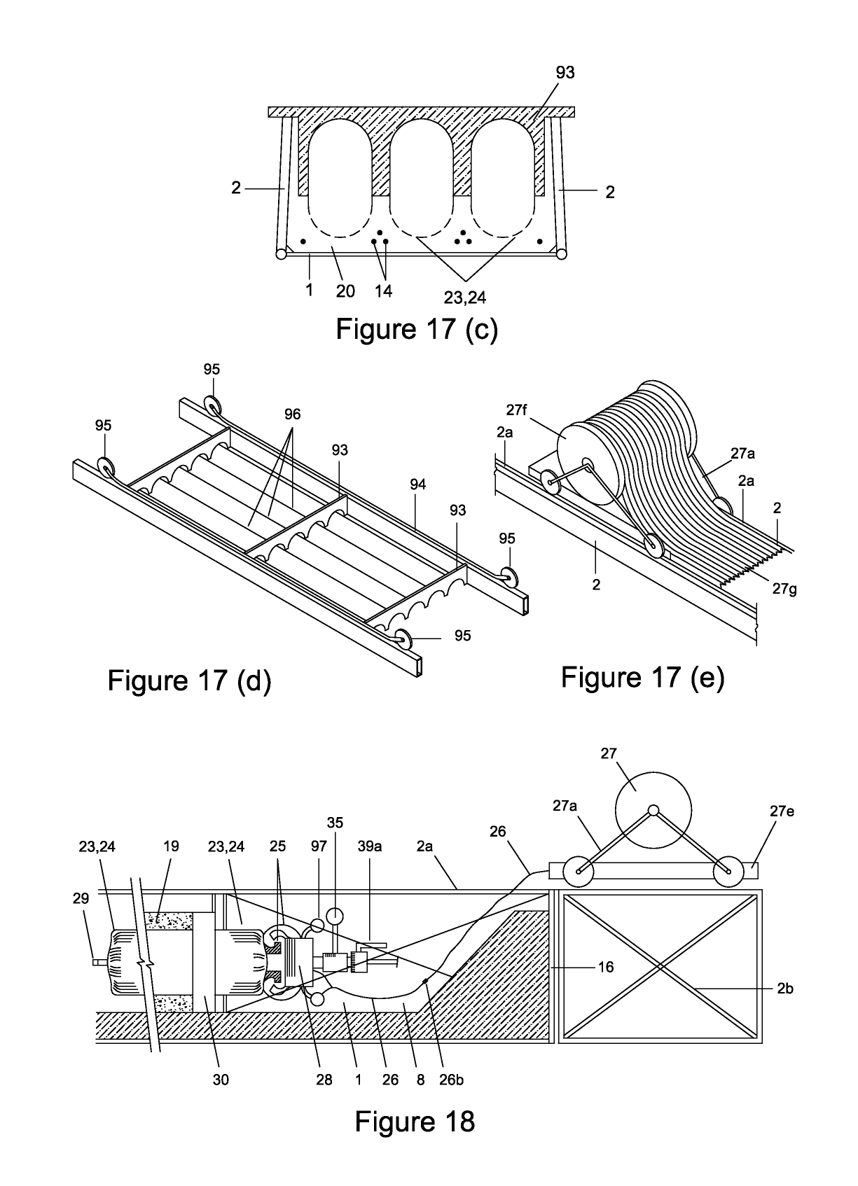

The feed skip 91, shown in FIG. 17(a) by way of example, which contains the concrete can discharge the mix, shown with arrows, evenly via an interchangeable chute 92 into the individual web area between each of the core formers 23 and sleeves 24. For each type of hollowcore slab 3 with varying quantities and diameters of cores or voids 19 there would be different chutes 92 Chute 92 could also be attached to the discharge chute of the ready mix truck, for example, or the whole apparatus 91 and 92 contained on a base with wheels to rest on rail 2a and travel up and down the length of casting bed 1 by manual or mechanical means.

On many typical hollowcore slabs 3 to be cast there would be no need for any additional reinforcement as previously described in FIGS. 8 and 11. Also the use of rigid cross bar 42a would be redundant. However, all hollowcore slabs 3 would always accommodate the four extended loops 40 part of cover blocks 37, shown in FIG. 9(a), or four extended loops 69 in FIG. 14(a). It may still be necessary nonetheless to restrain the core formers 23 and sleeves 24 from upwards flotation as the concrete enters the mould. This can be achieved by a specially shaped restraining plate 93, see FIG. 17(b), which spans across the two shutters 2 and can either be locked into place, as previously described, or held down manually by the casting crew as the concrete fills individual hollowcore slab moulds. By way of example, restraining plate 93 is shown for a 300 mm deep slab section 20, with four core formers 23 and sleeves 24, and FIG. 17(c) shows a 470 mm deep slab section 20 with three oval core formers 23 and sleeves 24. The underside of restraining plate or holder 93 is the precise upper semi circular shape of the inflated core formers 23 and sleeves 24. In this way, as the concrete fills the mould, core formers 23 and sleeves 24 are held rigidly in their correct location so that there would be no upward flotation or sideways deflection. Restraining plates 93 can be made out of steel or timber and being narrow, for example 3 to 6 mm, are retained in the mould until the concrete has completely filled the mould up to the correct height. Thereafter, restraining plates 93 are removed and cleaned. At this stage, all the core formers 23 and sleeves 24 are fully encapsulated by concrete and will remain in their correct locations in the mould. In a factory where a high production output is required, multiple restraining plates 93 can be held in a frame 94, shown in FIG. 17(d), which can be designed to accommodate one complete length of the current hollowcore slab mould being filled with concrete.

Frame 94 resting and anchored onto rail 2a can be designed to lock into place as many restraining plates 93 that maybe required. The number of restraining plates 93 along the length of an individual hollowcore slab mould could also be reduced by incorporating bar 96, preferably being rigid, continuous and formed from steel. The bar 96 is locked between adjacent restraining plates 93. Frame 94 can be made with four wheels 95 allowing 94 to move down the casting line 1 to another appropriate centralised discharging point over each mould length. Before moving, frame 94 would be raised from the fresh cast concrete manually or mechanically.

Once the casting operation has been completed, the top surfaces of all the hollowcore slabs 3 are covered with a suitable curing membrane over the entire length of casting line 1. Once again, carriage 27a is used to transport a special reeling drum 27f in FIG. 17(e) which is lifted into place on the central supporting legs of carriage 27a. Reeling drum 27f contains a continuous length of a polythene or similar curing sheet 27g which is systematically laid over the surface of all the hollowcore slabs 3 between the top of each shutter 2 on casting line 1. Rail 2a allows carriage 27a to pass uninterrupted down the full length of casting line 1 whilst the operators unwind and lay reeling drum 27f to ensure there is no air gap between the top of the shutters 2 and sheet 27g in FIG. 17(e). Once the full length of sheet 27g has been laid, carriage 27a is returned to its docking station past end 16. Empty reeling drum 27f is then removed from carriage 27a and placed in the designated storage area.

Some four to five hours after the casting of casting line 1 has been completed air valve 28 in FIG. 5(a) and FIG. 18 at the end of casting line 1 is released from the end of core formers 23 and sleeve 24 by a cam lever coupling 97. The pressure of air in core formers 23 will rapidly reduce by exiting through the large diameter orifice holder at lanyard 25 which held air valve 28 and is bonded to the end of core formers 23 and sleeves 24, see FIG. 18. Shaft 27 is now brought back from the temporary stock area and relocated on carriage 27a which remains on rail 2a past end 16. The two loose ends of connector 26 are joined together via pin 26b. The process to now remove core formers 23 and sleeves 24 from the complete cast length of casting line 1 takes place.

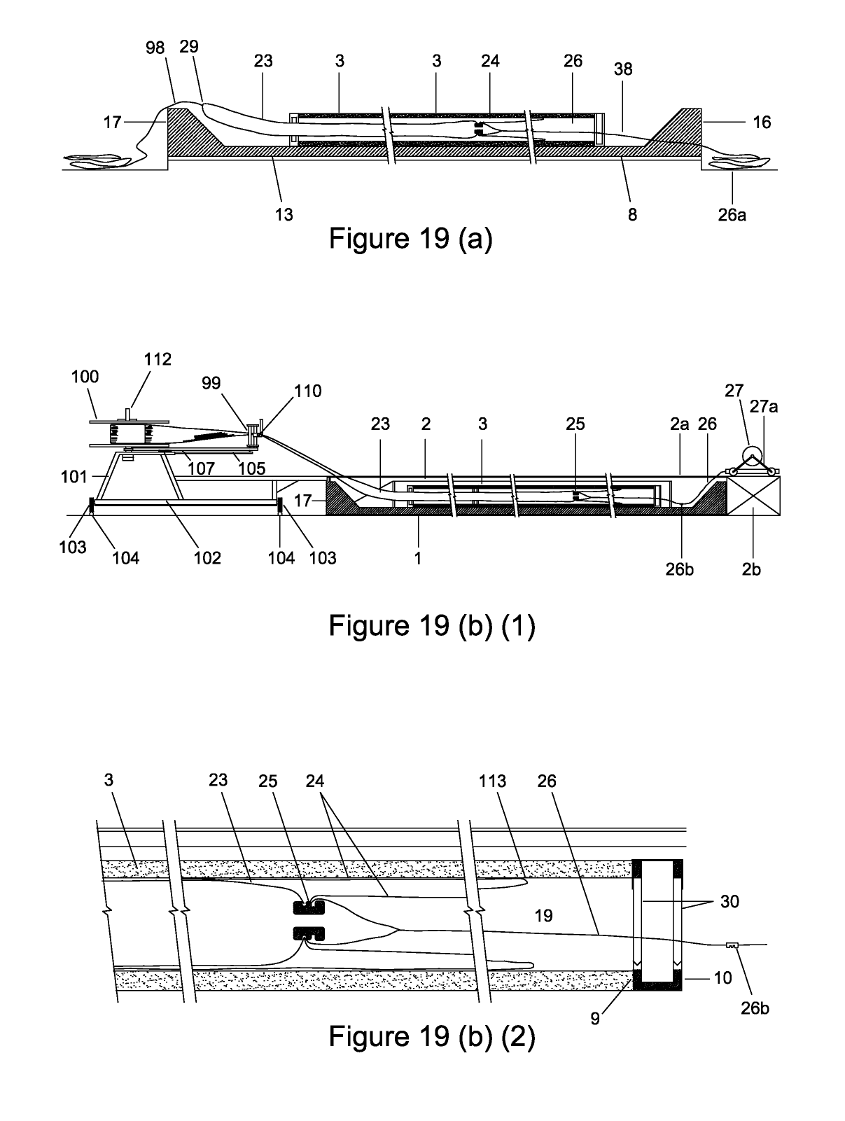

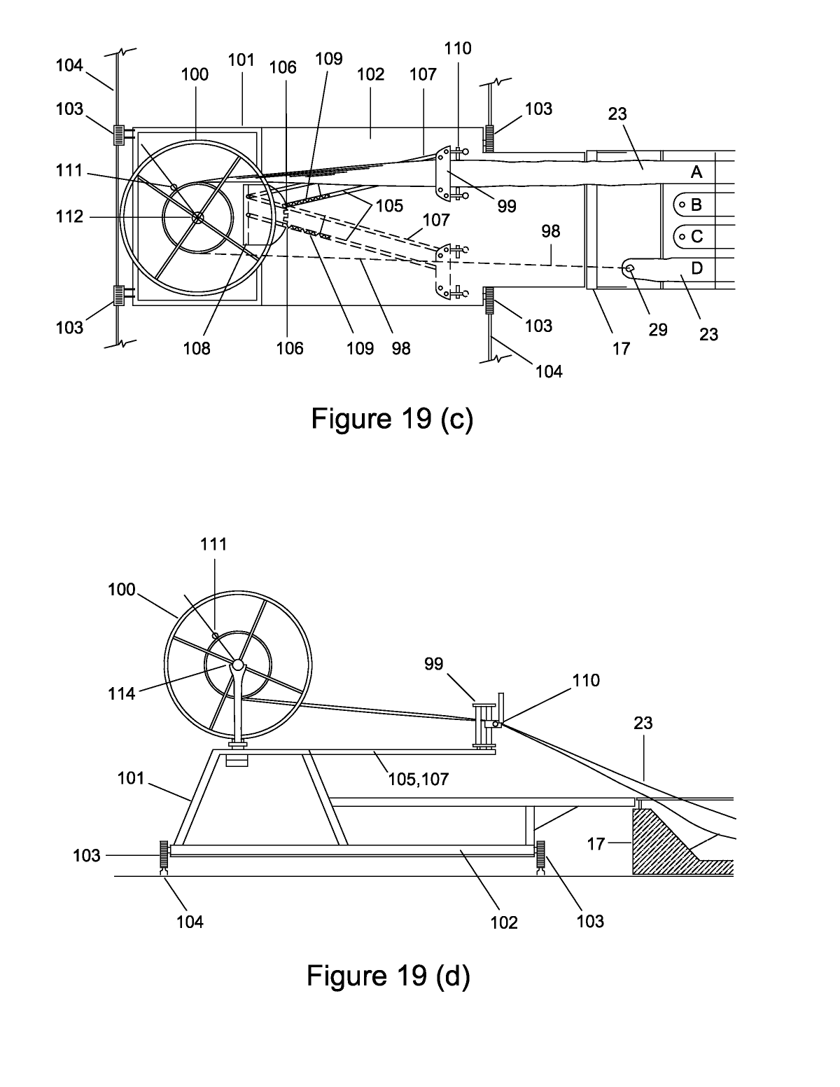

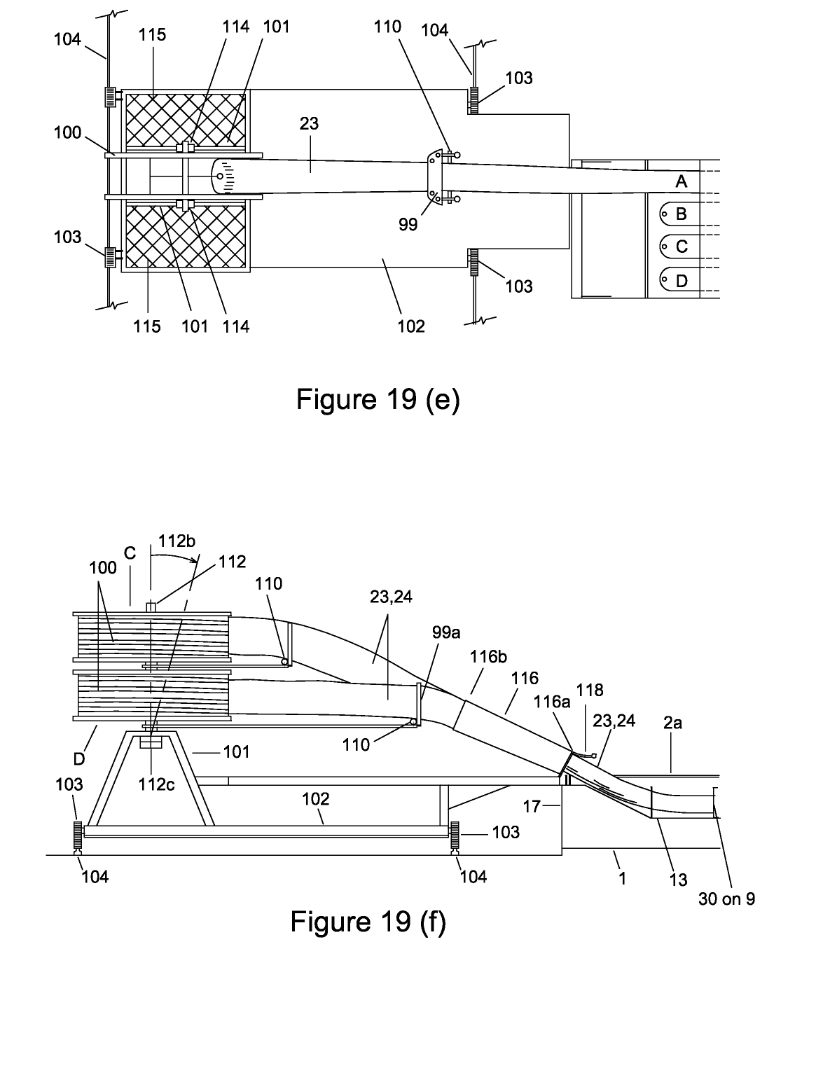

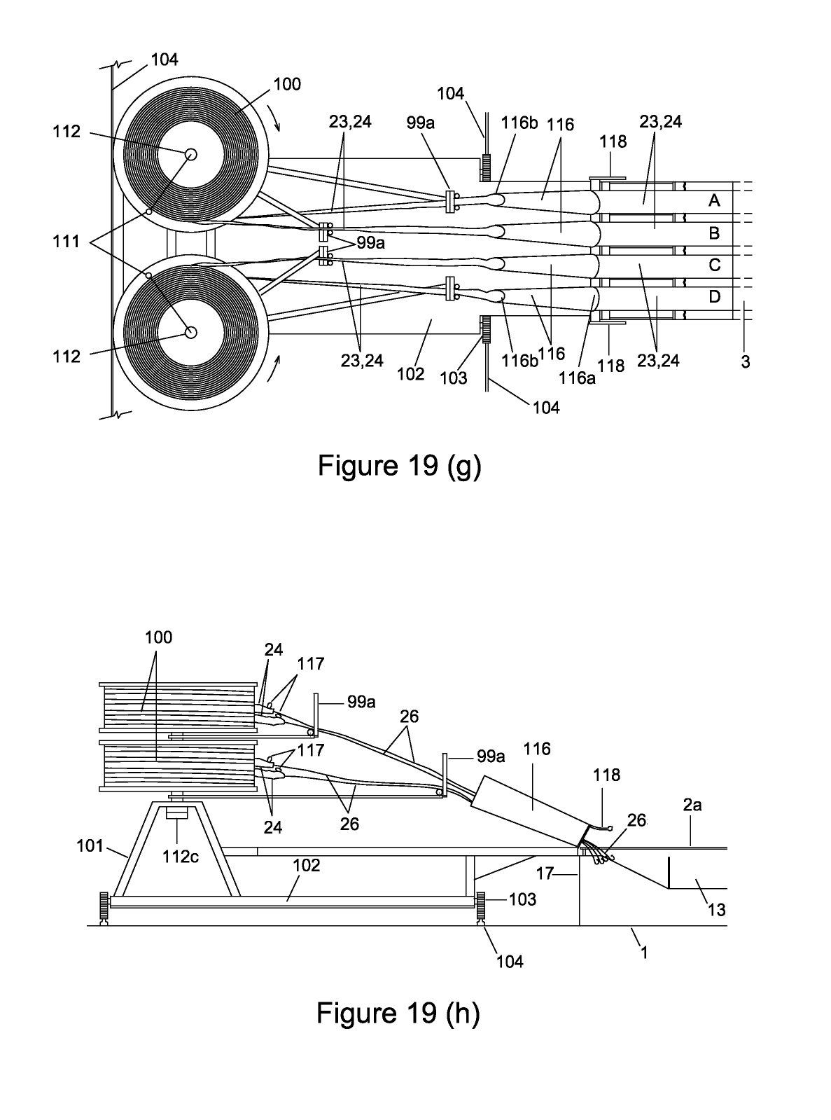

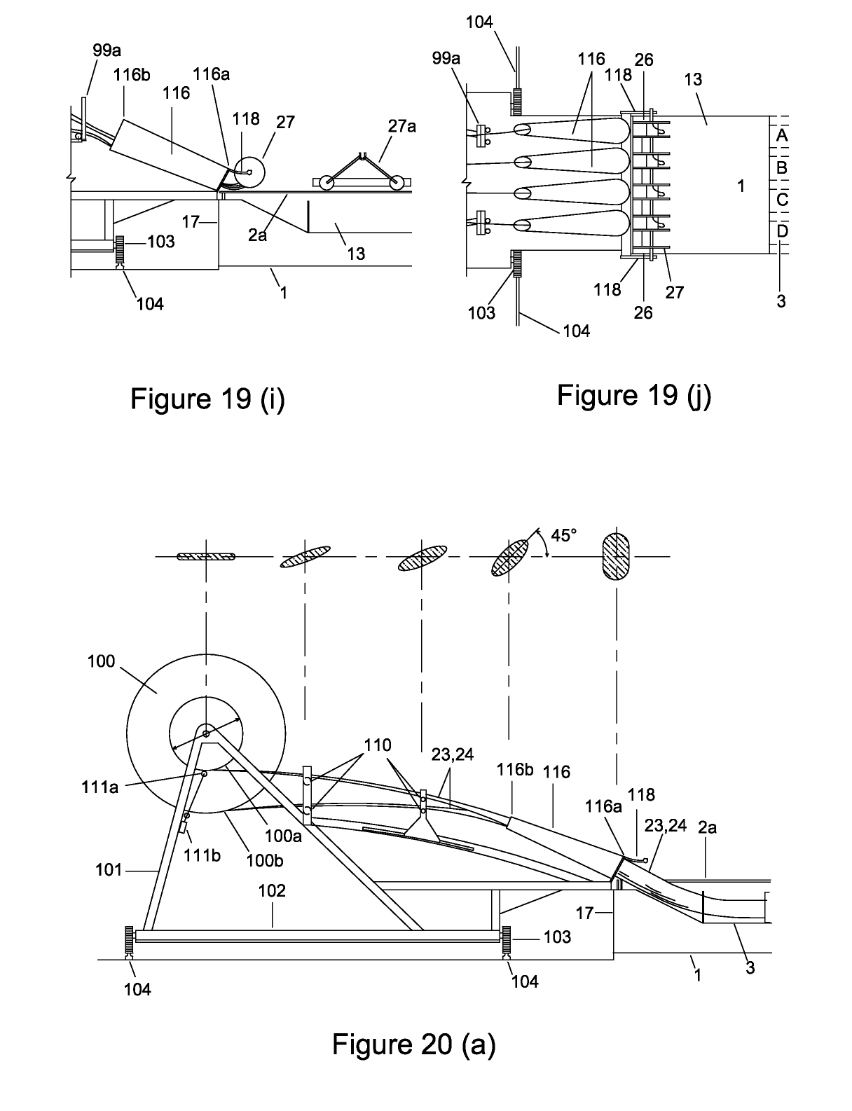

There are five methods of removing the core formers 23 and sleeves 24. The first method, shown in FIG. 19(a) for short lengths, being typically 10 to 20 metres of casting line 1 requires a hooked rope 98 with a hooked end to be attached to the horizontal ring eye 29 at the ends of each of core formers 23 at end 13 of casting line 1. The operator pulls the free end of hooked rope 98 until the individual full length of core formers 23 and sleeves 24 and ropes 26 stored at location 26a, are completely removed from the cast concrete cores revealing the series of cores or voids 19. Core formers 23 and sleeves 24 are finally rolled up by hand and removed to the stock area.

The other four methods are mechanically operated involving a separate storage apparatus and maybe used when casting line 1 is from 10 to 200 m in length. To simplify the explanation of the originality of the removal and relaying of core formers 23 and sleeves 24, with lengths from 10 to 200 m, the typical section 20 in FIG. 3 with four sets of formers 23 and sleeves 24 and ropes 26 is used.

For the second and third methods a simplified storage apparatus can be employed where the hollowcore factory has a small production capacity or is in a remote site with limited infrastructural facilities. The principle of removing core formers 23 and sleeves 24 however remains the same for all four remaining methods except that in the second and third methods core formers 23 and sleeves 24 are removed individually whilst in the fourth and fifth they are removed in multiples of up to possibly six simultaneously. This reduces operating work times which is of critical importance in a large hollowcore factory complex.

In the second method hooked rope 98, once again, is attached to the end of ring eye 29 of the relevant core former 23 and sleeve 24, and is initially passed through a guidance and flattening device 99 and thereafter attached to the central shaft of a horizontal reel 100, shown in FIGS. 19(b), and 19(c). Horizontal reel 100 is supported on a frame 101 and is part of a mobile storage platform 102 which has been moved from the stock area of the production facility and remains stationary in line with casting line 1 at the end 17. Platform 102 is supported via four wheels 103 and rests on steel rails 104 running normal to the longitudinal extent of casting line 1. Rails 104 are set at a specific distance from end 17 in FIGS. 2 and 19(c) to ensure extended strand wires 14, from the stressing operation, are always avoided.

Guidance and flattening device 99 can be locked into the pathway of either of the centre lines from core formers 23 and sleeves 24 located at A, B, C and D, FIGS. 3 and 19(c). FIG. 19(c) shows guidance and flattening device 99 locked to accept core former 23 and sleeve 24 at A. With core former 23 and sleeve 24 removed from A guidance and flattening device 99 can then be re-located centrally over core former 23 and sleeve 24 at B and the removal process repeated. Guidance and flattening device 99 is normal to the line of the moving core former 23 and sleeve 24 to ensure there is no crabbing as they are wound onto horizontal reel 100. The operator unlocks the location of guidance and flattening device 99 which is connected via a support bar 105 hinged at pivot 108. A second support bar 107 runs parallel to support bar 105 and is also pivoted at hinge 108 and at guidance and flattening device 99. A repeat of hinged support bar 105 and second support bar 107 is shown in dotted lines to demonstrate a different location of guidance and flattening device 99. Also hooked rope 98 shown as a dotted line and connected to ring eye 29 defines its pathway from core former D to reel 100 at the first stage of removal from hollowcore slab 3. Once core former 3 on D passes guidance and flattening device 99 and roller 110 it aligns up with the centre line of D.

To move guidance and flattening device 99 horizontally a spring mounted latch 109 mounted on top of the two support bars 105 is pulled back to release its end from notch 106. Guidance and flattening device 99 is then moved manually or mechanically and relocated into another notch 106, for example to align guidance and flattening device 99 over the centreline of D. When in approximately the right position the spring mounted latch 109 is released into the notch 106 and guidance and flattening device 99, support bar 105 and second support bar 107 are locked into place. Centerline of hinges 108 for bars 105 and 107 and the line of horizontal roller 110 on guidance and flattening device 99 form a quadrilateral rectangle such that regardless of the fixed location of guidance and flattening device 99 with each of A, B, C or D it will always be at a normal to the individual centrelines of these four core formers 23 and sleeves 24. Passing over roller 110 held by guidance and flattening device 99 core former 23 and sleeve 24 are kept in tension and then turned through 90 degrees to be tightly wound on horizontal reel 100. Spring located brake device 111 can be operated to ensure that compaction of the core former 23 and sleeve 24 wound onto horizontal reel 100 is maintained at all times.

Once a complete core former 23 and sleeve 24 have been wound onto the horizontal reel 100 the reel is removed, by crane or manual labour, from the vertical central support 112 supported from frame 101 and moved to the stock yard area for re-use for the next production cycle. An empty horizontal reel 100 is now placed over shaft 112 and guidance and flattening device 99 is lined up for removal of a further core former 23 and sleeve 24.

As core formers 23 are removed from the last cast core, FIGS. 19(b)(1) and 19(b)(2), the deflating outer surfaces slide smoothly against the inner surfaces of sleeves 24 which initially remain bonded to the final concrete core shapes, now being the cores or voids 19. Both core former 23 and sleeve 24 are anchored to the end of lanyard 25 and as core former 23 passes down its respective core or void 19, it pulls sleeve 24 behind it folding sleeve 24 back on itself. As the full length of sleeve 24 leaves the last upper divider 30, dividers 9 and hollowcore slab 3 at end 13, it is completely turned inside out. Position 113, enlarged in FIG. 19(b)(2), is a typical turning point where sleeve 24 is turned inside out. The pulling action of core former 23, down the length of each core or void 19, creates a clean separation of sleeve 24, around its full circumference, away from the surface of core or void 19. Rope 26 being still attached to lanyard 25 is also pulled down core or void 19 by core former 23 and remains inside the full length of sleeve 24 and completely unwound from shaft 27 resting on carriage 27a.

In the third method, hooked rope 98 once again is attached to the end of ring eye 29, of the relevant core formers 23 and 24 and once again is initially passed through a guidance and flattening device 99 and thereafter attached to a central shaft of a vertical reel 100 instead of horizontal, shown in FIGS. 19(d) and 19(e). Vertical reel 100 is identical in all respects to that depicted in FIGS. 19(b) and 19(c) for the horizontal reel 100 except for one important difference. Whilst core formers 23 and sleeve 24 are turned through 90 degrees as they leave guidance and flattening device 99 and are wound onto horizontal reel 100. With a vertical reel 100, core former 23 and sleeve 24 remain flat at all times, and are wound onto vertical reel 100 flat and horizontal. Thus the alignment of guidance and flattening device 99 must at all times be in the direct pathway of the centreline of the core former 23, sleeve 24 and vertical reel 100. If core former 23 and sleeve 24 were deflected sideways as they leave guidance and flattening device 99 to meet an off centre vertical reel 100 they would become twisted and it would not be possible to wind the full length of core former 23 and sleeve 24 onto the reel. The whole would become tangled together as the winding process continues. There thus is no requirement when winding core formers 23 and sleeve 24 to have a moveable apparatus guidance and flattening device 99 to align the particular core former and sleeve. Instead at all times, before core former 23 and sleeve 24 are removed when using vertical reel 100 the entire storage platform 102 must be aligned over the centreline of the core former 23 and sleeve 24 as clearly shown in FIG. 19(e) where core former A is being extracted. Guidance and flattening device 99 with its two support bars 105 and 107 is now rigidly fixed between the centreline of the vertical reel 100 and the centreline of the core former 23 and sleeve 24 being extracted.

Once core former 23 and sleeve 24 have been fully wound onto vertical reel 100, the reel is removed in a similar method as horizontal reel 100. Vertical reel 100 in this case being lifted from the two support arms 114. Support frame 101, on which 114 rests, is in line with 114 to allow the operator to stand close to the vertical reel 100 whilst it is removed. Chequered plate floor platform 115 or similar is shown in FIG. 19(e). The process as previously described is then repeated to remove other core formers 23 and sleeve 24, for example B, C and D, by initially placing an empty vertical reel 100 onto support 114.

As previously explained the fourth and fifth removal methods of core formers 23 and sleeve 24 involve simultaneous removal of multiple horizontal reels 100 as the fourth method, and multiple vertical reels 110 for the fifth and final method. The explanation for multiple removal of core formers 23 and sleeve 24 for the fourth and fifth method uses the same four number core formers 23 and sleeve 24 located at A, B, C and D, in FIGS. 3 and 19(c) as previously described.

FIGS. 19(f) and 19(g) show two horizontal reels 100 which are positioned one above the other and both supported by frame 101, with a further two adjacent reels 100 supported by another frame 101. Both frames 101 rest on one platform 102.

Once past end 13, core formers 23 and sleeves 24 pass into tube 116 at opening 116a, shown in FIGS. 19(f) and 19(g). The other end 116b of tube 116, is deliberately shaped as a vertical oval tube. Rotating horizontal reel 100, as it continues to pull core former 23 past end 116b squeezes air out of core former 23 as it becomes elongate. Leaving end 116b, core former 23 and sleeve 24 pass through horizontal and vertical guidance flattener 99a, which not only flatten the core former 23 and sleeve 24 further but also guides them onto horizontal reels 100 ensuring that closely aligned core formers 23 and sleeves 23 do not clash. Movable tensioning device 111 ensures the core formers 23 and sleeves 24 are also tightly packed onto the reels 100 during the removal operation. When winding all four core formers 23 and sleeves 24, reels 100 containing core formers 23A, B and sleeves 24A, B rotate clockwise whilst reels 100 containing core formers 23C, D and sleeves 24C, D rotate anticlockwise. FIG. 19(g) shows the majority of the lengths of individual core formers 23 and sleeves 24 wound onto reels 100. The rotational axis, typically being vertical, of the supporting central shaft at 112 of reels 100 in FIG. 19(f) can be angled, 112b, towards tube 116 and raised or lowered in height as necessary to accommodate different thicknesses of core formers 23 on the one hand and to also reduce the angle of deflection on core formers 23 and sleeves 24 as they pass rollers 110 on the other.

With all four sets of core formers 23 and sleeves 24 fully wound onto reels 100, the ropes 26 will continue for at least a further 3 to 4 metres and remain protruding out of the opening of each tube 116 in FIG. 19(h). Two small lengths of string attached to each connector 26 at a point some 100 mm before the end of each sleeve 24 are passed through two ring eyes 117 in or at sleeve 24 and tied in a knot to temporarily bond the end of connector 26 to sleeve 24.

The now empty shaft 27, resting on carriage 27a on rail 2a behind end 16, FIGS. 18 and 19(b), is transported back to end 13. Shaft 27 is removed from carriage 27a and placed on the ends of arms 118 which are cantilevered from the end of the cantilevering support base of the four tubes 116 at openings 116a in FIG. 19(i). The loose ends of the four ropes 26 are now attached to the four individual reels on shaft 27 from the underside in line with centre line of tube 116, see FIG. 19(j) which is an enlarged local plan view. Temporarily redundant carriage 27a can be left at end 13 or returned to behind end 16.

Platform 102 in FIGS. 19(h), 19(i) and 19(j) is now moved to whichever side of casting line 1 is the designated storage area. Effectively, the use of platform 102 is now ‘off the critical path’ of the hollowcore slab removal cycle.

For the fifth method of removal of core formers 23 and sleeves 24, once again a separate storage apparatus is used but hooked rope 98 this time is attached to a vertical reel 100, which is identical in all other respects to the horizontal reel 100 used in the third removal method. For clarity, the same related numbers for the third method of removal are used throughout this description of the fifth method of removal.

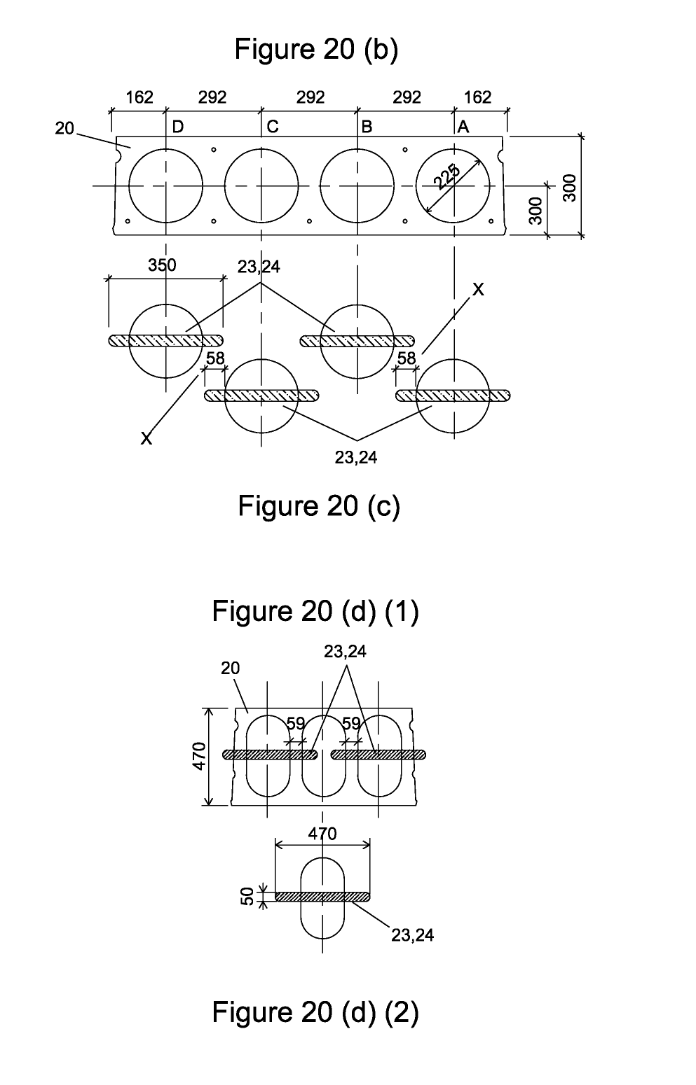

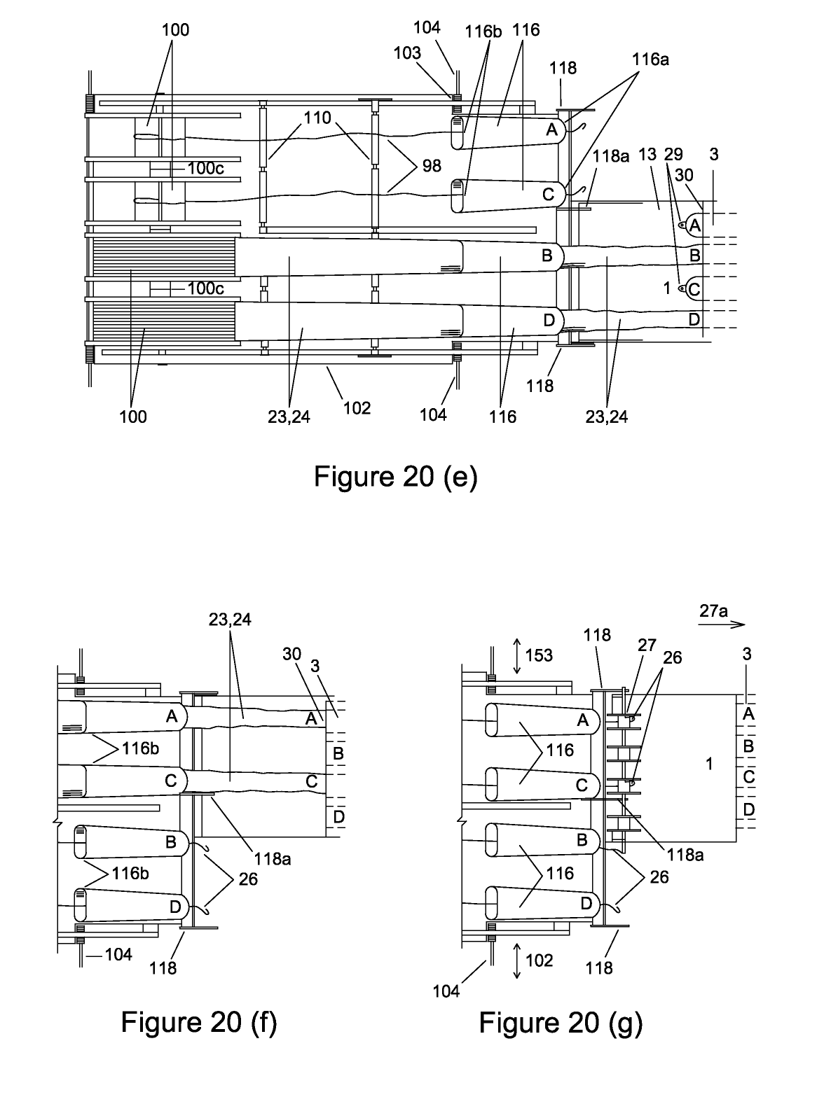

Vertical reel 100 is supported by frame 101 in turn resting on platform 102, see FIG. 20(a). When core formers 23 and sleeves 24 are compressed, as they pass through tube end 116b and over rollers 110 the two elongated, now flattened top and bottom, surfaces come to within 5 to 10 mm of each other. But most importantly the flattened core formers 23 and sleeves 24 will be approximately 55% wider than the originally inflated diameter. Thus a 100 mm diameter core former 23 and sleeve 24 will elongate to approximately 155 mm wide, and a 190 mm core former 23 and sleeve 24 to approximately 295 mm, and so on.

From FIG. 3, it can be seen that multiple cores or voids 19 are placed very close to each other for reasons previously explained. The arrangement of FIG. 20(b) can be a replica of the arrangement of FIG. 3 with typical key dimensions added by way of example. Cores or voids 19 in FIG. 20(b) would have an overall flattened width of around 350 mm FIG. 20(c) shows four adjacent flattened core formers 23 and sleeves 24 with two core formers 23 and sleeves 24 schematically placed below the other two core formers 23 and sleeves 24 for clarity, but on the same vertical centre line. The overlap of two core formers 23 and sleeves 24 onto the remaining two core formers 23 and sleeves 24 is marked X, in other words being 58 mm The overlapping problem is compounded when deep slab sections 20 are employed. For example, 470 mm deep hollowcore slabs 3 where the oval core formers 23 and sleeves 24, once flattened, will have an increase in width of some 120% compared to the inflated width, see FIG. 20(d). Whilst it is possible to remove any two adjacent core formers 23 and sleeves 24 for any slab section configuration and simultaneously wind them onto reels 100 and maintain a straight line of feed as previously described, the overlapping core formers 23 and sleeves 24 will double up the diameter on one side of reel 100 compared to the other side where only a single core former 23 and sleeve 24 is being wound. This will lead to incessant tangling and twisting of the adjacent core formers 23 and sleeves 24 creating extreme difficulties when trying to wind or unwind the core formers 23 and sleeves 24.

The solution therefore for the fifth method of removing both round and oval horizontally flattened core formers 23 and sleeves 24 but wound onto vertical reels 100 is to remove them alternately across slab section 20, leaving an immediately adjacent core former 23 and sleeve 24 to be removed in a second operation. This two phase principle will apply to all sizes of slab sections 20 running from 150 mm deep up to 600 mm regardless of the number of core formers 23 and sleeves 24 used. FIG. 20(e) shows typical core formers 23 and sleeves 24 as they leave upper divider 30, dividers 9 and hollowcore slab 3, leaving behind cores or voids 19 individually lettered A, B, C, D with the same letters written on the tube 116 for clarity. In order to maintain a consistent straight line feed for core formers 23B, D and sleeves 24B, D onto reels 100 in the first phase, and the core formers 23A, C and sleeves 24A, C in the second phase, a substantial gap is created between the sides of each reel 100. Platform 102 therefore becomes much wider and it has to be moved along rails 104 in FIG. 20(f) to line the vacant reels 100 with casting line 1 before core formers 23A, C and sleeves 24A, C can be removed in the second phase.

In the removal mode of core formers 23 and sleeves 24, all four ropes 26 are fully wound onto their respective reels on shaft 27 so as to be ready to be unwound. However, before hooked ropes 98, core formers 23 and sleeves 24 are wound up by the vertical reels 100, for the first phase removal, the two separating pins 26b on each connector 26 for core formers 23B, D and sleeves 24B, D must be joined. They have been left separated from the previous laying operation. Ropes 26 for the second phase removal of core formers 23A, C and sleeves 24A, C are already joined from their reels on shaft 27 directly to lanyard 25. However if the first phase removal was core formers 23A, C and sleeves 24A, C, pins 26b on ropes 26 for core formers 23A, C and sleeves 24A, C would be separated and would have to be joined, and those for core formers 23B, D and sleeve 24 B, D, now being the second phase, would already be joined.

Core formers 23 and sleeves 24 leave the last upper divider 30, dividers 9 and hollowcore slab 3 at end 13 and pass into circular tube 116 at opening 116a as previously described. At end 116b tube is once again oval shaped in FIG. 20(e), but the long sides of the oval are horizontal for circular core formers 23 and sleeves 24 only, to ensure the core formers 23 will be horizontal as they approach rollers 110 where they are flattened further before being wound clockwise onto reel 100 feeding from the underside of the central shaft of reel 100.

With deep slab sections 20, for example, as can be seen in FIG. 20(d) the removal process is the same as for circular core formers 23 and sleeves 24. However, the tube opening 116a would be a vertical oval shape, some 2 to 3 mm less circumference than the inflated oval core formers 23 and sleeve 24 as previously described. Again, as the vertical oval core former 23 and sleeve 24 pass through tube 116, not only are they squeezed resulting in a substantial increase of the overall depth of the vertical oval shape, but they are also angled sideways, to start the process of making the long sides of the oval horizontal, enabling flat core formers 23 and sleeve 24 to be wound onto vertical reel 100. To reduce strain and the potential wear on the sides of the oval core former 23 and sleeve 24, end 116b is only angled from the vertical by 45 degrees. The varying sectioned circumferences of the deep section 20, FIG. 20(d), as it passes from the vertical to the horizontal and is finally wound horizontally onto reels 100 is depicted at the top of FIG. 20(a).

Using vertical reels 100 once again tensioning devices 111a ensure that core formers 23 and sleeves 24 are consistently flat and tightly packed to minimise the overall diameter of core formers 23. Sleeve 24 with connector 26 inside following behind core former 23 is a lighter weight material and its precise location on the surface of core formers 23 around reel 100, as it is wound up, is not so critical. Tensioning device 111a in FIG. 20(a) shows core formers 23 at the start of the winding operation on to reel 100 and when the tensioning device 111a is at location 100b core formers 23 and sleeves 24 are fully wound onto reel 100.

The now empty shaft 27, resting on carriage 27a is transported back from end 16, as previously described, and removed from carriage 41a and placed on the ends of arms 118 and arms 118a, seen in FIG. 20(g). Note: arms 118a are positioned immediately on the edge of tube 116 at opening 116a at C to provide an intermediate support for cantilevered shaft 27 because of the extended width of platform 102. Loose ropes 26 for core formers 23A, C and sleeves 24A, C are now attached to individual reels on shaft 27 as previously explained, whilst ropes 26 for core formers 23B, D and sleeve 24B, D lie protruding out of opening 116a. Platform 102, FIGS. 20(a) and 20(e), is now moved away to the stock area and is effectively off the critical path of the hollowcore slab removal cycle.

After some 6 hours depending on the strength of the concrete, the destressing operations and entire stripping of hollowcore slabs 3 from casting line 1 proceeds. Empty reeling drum 27f is now relocated onto carriage 27a and carriage 27a is run down the length of casting line 1 from either end 13 or end 8 with the operators winding up manually or mechanically sheet 27g in FIG. 17(e). Carriage 27a is then moved back to and past end 16 and reeling drum 27f is removed into the stock area to be used for the next casting operation. Empty carriage 27a is again, as necessary, moved down casting line 1 and all supports, for example, supports 32 in FIG. 1(a), and supports 33 in FIG. 7a and cross bar 55 in FIG. 12(e) are removed and placed in the base of carriage 27a and transferred to the end of casting line 1 and placed into stock to await the next casting operation. Shutters 2 each side of casting line 1 along the full length of casting line 1 are now hinged outwards, as in FIG. 1(c). At the same time carriage 27a is adjusted to accommodate the wider span of the two rail lines 2a on side shutters 2. Carriage 27a is once again moved down casting line 1 and all capping pieces 31 in FIGS. 7 (a), and (b), and 11(c), flexible units 21 in FIG. 4 and upper dividers 30 in FIG. 6, are placed in the base of carriage 27e and transferred to the end of casting line 1 as previously described. Strand wires 14 are now destressed at each end of casting line 1 in the conventional manner.

Thereafter individual strand wires 14 in the gap between the ends of each hollowcore slab 3 are cut either manually or mechanically by hydraulically operated cutters or cutting disc.

Individual hollowcore slabs 3 are then removed from casting line 1 and transported into the stock area for distribution to site. In the stock area, cutting discs are used to trim off the ends of strand wires 14 protruding from the end of each hollowcore slab 3.

As previously mentioned at this stage of the production process it is now possible to seal the ends of cores or voids as required where the cores or voids are used as a thermal mass medium as previously described and shown in FIG. 16(d). Whilst FIGS. 16(p) and 16(q) detail a method of sealing the ends of cores or voids, and the operation as previously described could be carried out also at this stage of the production process an alternative method is possible whereby there is no requirement to create a feed hole 53 in the top surface of the core or void. This second process can very easily be carried out in the stock yard area or indeed on the site where the hollowcore slab 3 has been installed.

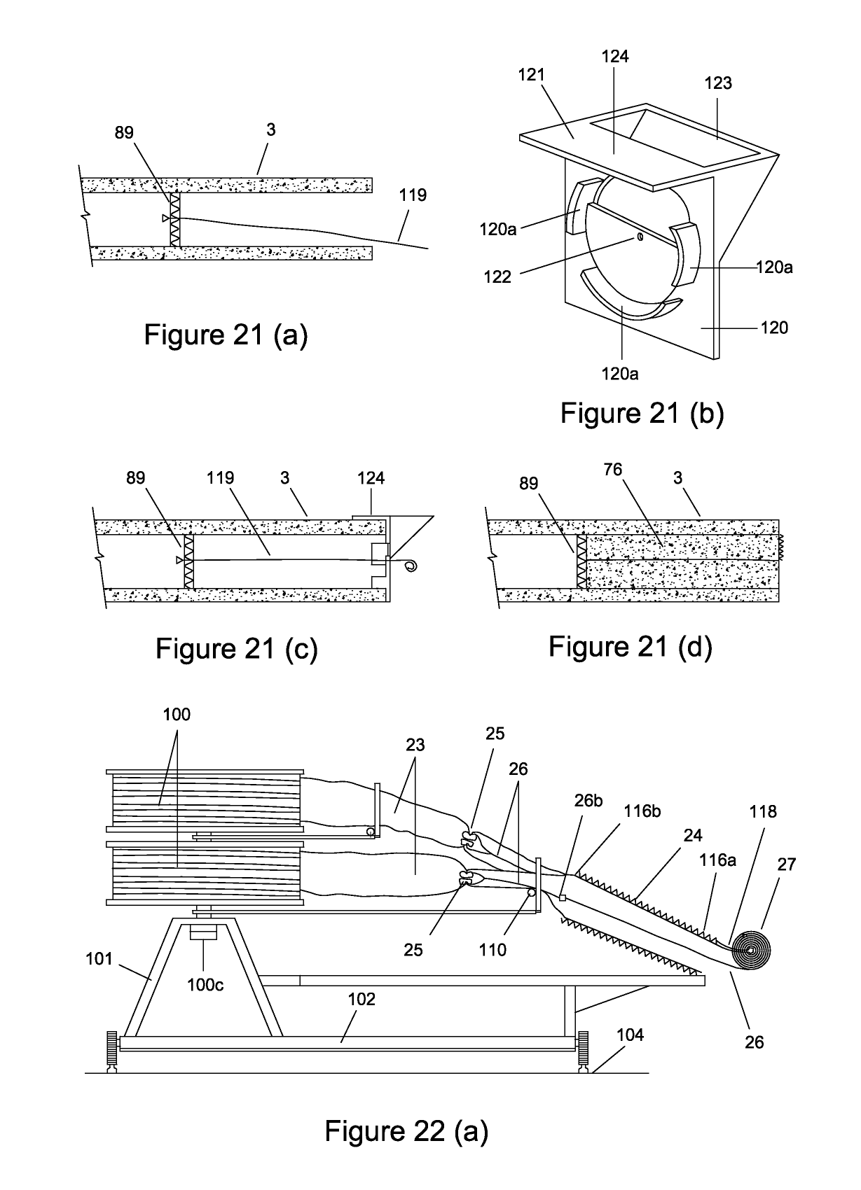

FIG. 21(a) shows a cross section through a core or void at the end of a typical hollowcore slab 3 which requires to be sealed. And an appropriate baffle 89 similar to that shown in FIG. 16(q) is placed at an appropriate distance inside the core or void runs. A length of string or wire 119 connected to the baffle 89 is laid past the end of the hollowcore slab 3. FIG. 21(b) shows a perspective view of a specially fabricated end stopper and concrete feed apparatus 120 which could be made of a cemititious or plastics material. The end apparatus 120 is wedged into the core or void at the end of the hollowcore slab 3. The diameter of the core or void lugs 120a are slightly less than the diameter of the core or void in hollowcore slab 3. Once end apparatus 120 is in the core or void lugs 120a ensure that end apparatus 120 remains lodged in place. A top cover plate 121 at right angles to the vertical line of the end apparatus 120 rests on top of the hollowcore slab 3. Cross section through end apparatus 120 attached to end of hollowcore slab 3 is depicted in FIG. 21(c). String/wire 119 attached to the baffle 89 is passed through the locating hole 122 in end apparatus 120 FIG. 21(b), and tightened such that the force of any concrete entering the core void between the end apparatus 120 and baffle 89 will be retained. Angled open-ended bucket 123 cantilevering from the outside surface of end apparatus 120 allows flowable concrete to then be poured directly into the core void between the end of end apparatus 120 and baffle 89. A deadweight 124 can be positioned on top of cover plate 121 FIGS. 21(b) and (c) to restrain the end apparatus from moving whilst the concrete is poured into the core or void.

Each individual core or void would have a separate individual end apparatus 120. Once the concrete inside the core or void has set the end apparatus 120 can be prised from the end of the hollowcore slab 3 having first released the string/wire 119. The end apparatus can then be cleaned and reused at a later date. The string/wire 119 is then cut at the end of each of the core or void in the individual hollowcore slab 3 that has been sealed leaving a clear end seal at the end of each core or void.

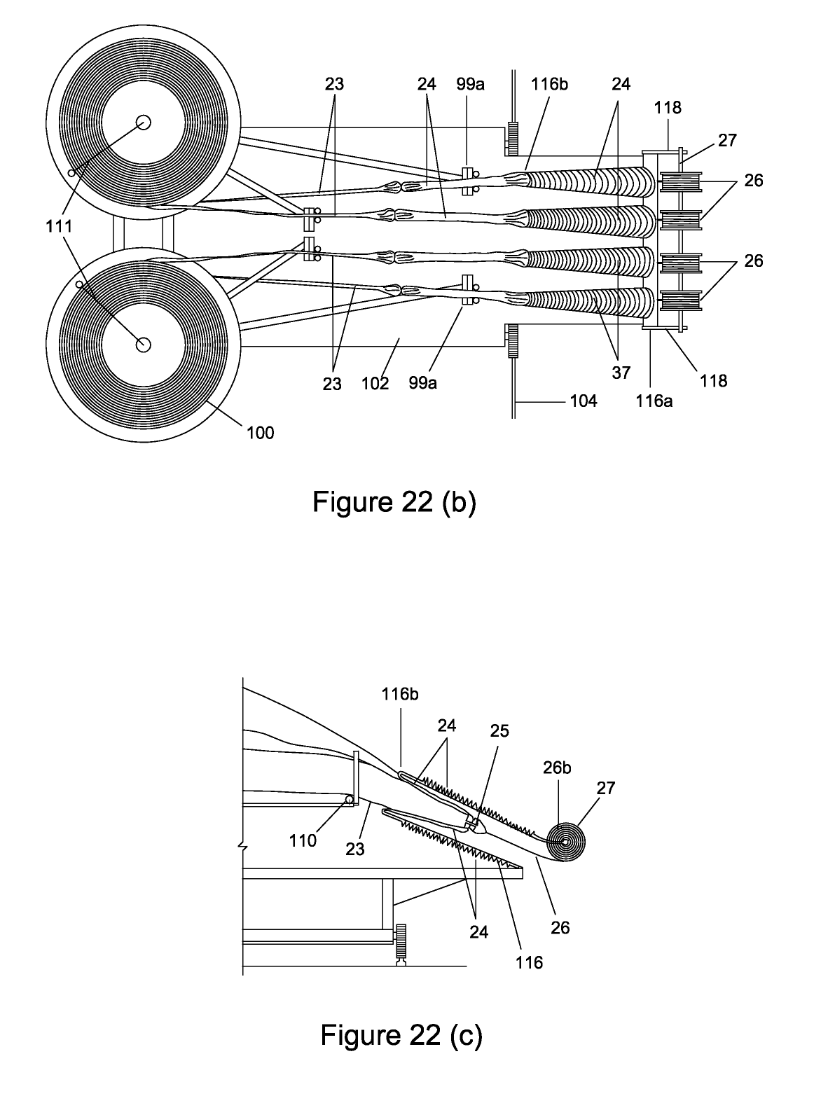

During the extended curing time that platform 102, using either the fourth or fifth removal method of core formers 23 and sleeves 24, is retained in the stock area, factory operatives can prepare the core formers 23 and sleeves 24 for relaying along casting line 1 prior to the next production cycle. Shaft 27 for horizontal reels 100 is now rotated manually or mechanically anticlockwise winding up ropes 26. As the ends of sleeves 24 approach the ends 116b, the two strings on each connector 26 are untied and released from ring eyes 117, FIG. 19(h). The now open end of each sleeve 24 is placed over tube 116 at end 116b, see FIG. 22(a) and FIG. 22(b). Rope 26 continues to be wound onto shaft 27 pulling lanyard 25 towards end 116b. At the same time, sleeve 24 is ruched up manually or mechanically over tube 116. Note, in FIG. 22(a), sleeve 24, lanyard 25 and tube 116 are shown in section for clarity. Tube 116 as previously explained has a 2 to 3 mm smaller circumference than sleeve 24, allowing sleeve 24 to slide easily over the full length of tube 116 from end 116b to opening 116a. When most of the length of sleeve 24 has been ruched onto tube 116, lanyard 25 will be near to end 116b, trailing core former 23 behind it. Rope 26 continues to be wound onto shaft 27, and as lanyard 25 passes end 116b and goes inside tube 116, FIG. 22(c), part section the end of sleeve 24, also attached to lanyard 25, begins to be pulled off tube 116 and travels back to and around end 116b turning back on itself following behind lanyard 25. Sleeve 24, once inside tube 116, is now turned inside out as it enters tube 116 again, and surrounds core former 23 as the original protection sleeve for core formers 23.

Horizontal rollers 110 can be raised or lowered as necessary, see FIGS. 22(a) and 22(c), to ensure ropes 26 and core formers 23 enter the middle area of the void created by the circumference of tube 116 at end 116b. Frame 102, supporting reels 100, incorporates a disc braking device 100c, at the base of 100, to ensure that as reels on shaft 27 winds up connector 26, core former 23 and ultimately sleeve 24 as they pass through end 116a, there is no ‘slack’ in the line of connector 26 and core formers 23. The disc braking device also ensures that core formers 23 and sleeves 24 do not unravel loosely from reels 100 in the event of a slowing down or halt whilst being laid down casting line 1. Platform 101, containing reels 100 and support frame 102 as shown in FIG. 22(a), is now ready for the next production cycle although still located in the stock area.

The methodology for the preparation of core formers 23 and sleeves 24 for relaying down casting line 1 using vertical reels 100 is also carried out and is identical to the relaying of core formers 23 and sleeves 24 using the horizontal reels 100 except the process is in two phases.

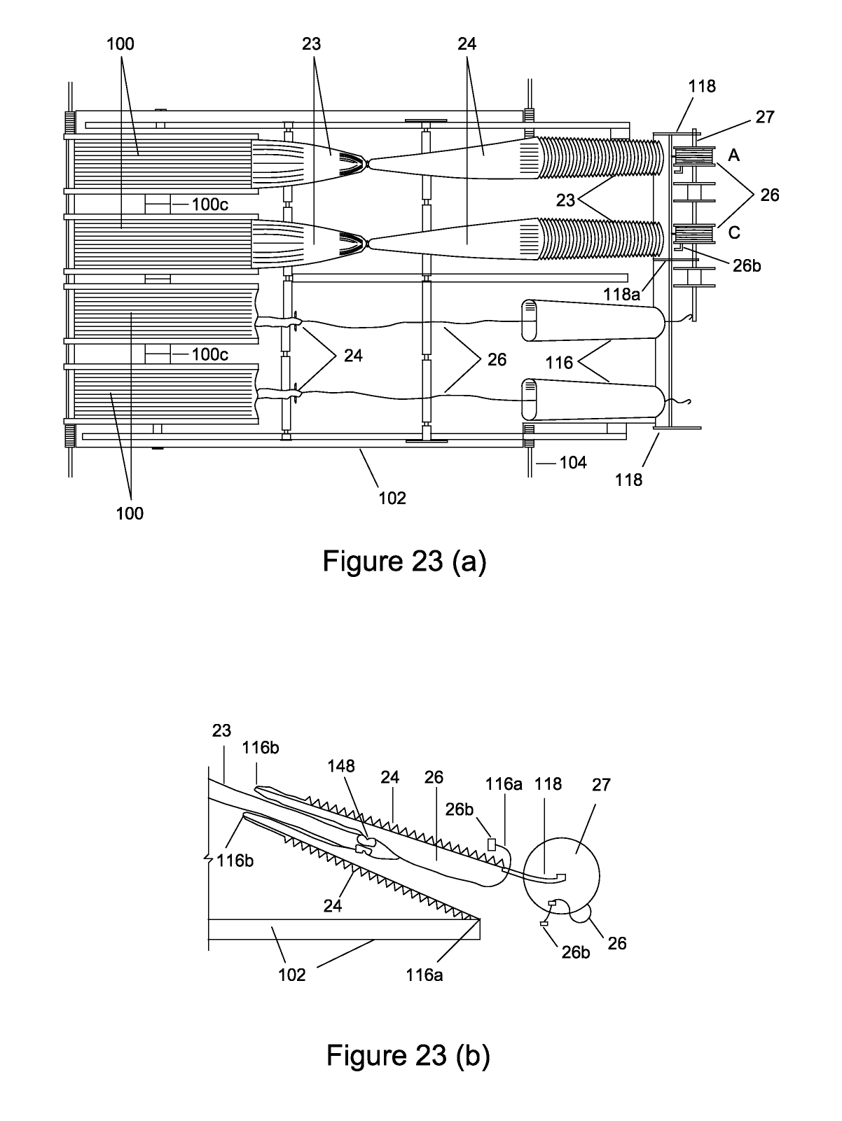

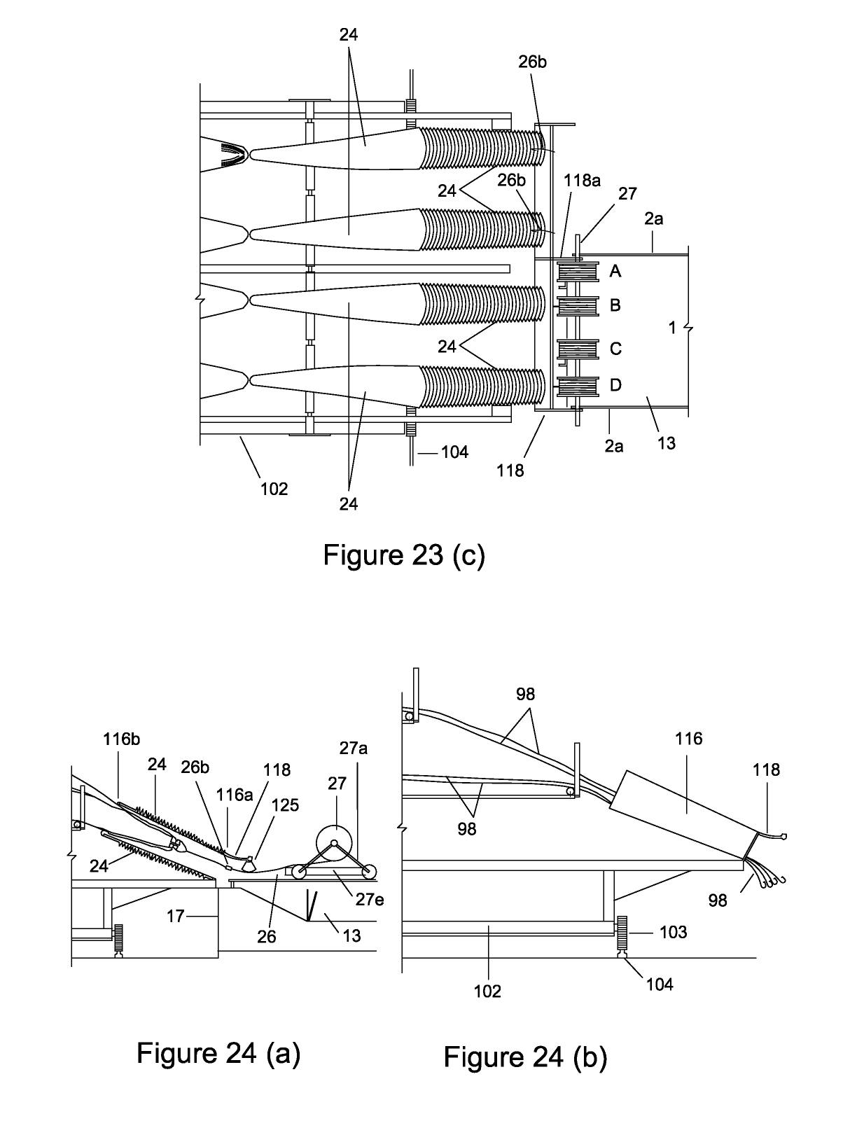

The ropes 26 for core formers 23A, C and sleeves 24A, C attached to shaft 27 are wound onto shaft 27 and the entire winding and ruching operation as previously described is carried out. FIG. 23(a) shows sleeves 24A, C ruched up onto tube 116 and ropes 26 completely contained on the appropriate reel on shaft 27. Multiple disc braking device 100c is now placed against the horizontal central shafts of reels 100 in FIG. 23(a). FIG. 23(b) shows an enlarged section and side view of tube 116. Separating pin 26b on connector 26 is then released. The end of connector 26 attached to lanyard 25 is looped over the top of end 116b and the other end of connector 26 is secured to the side of the relevant reel on shaft 27. Shaft 27 is removed from arms 118 and arms 118a and repositioned over the same arms 118a and the arms 118 located each side of core formers 23B, D and sleeves 24B, D, FIG. 23(c). Ropes 26 are now wound up onto the reels on shaft 27 and the ruching operation for sleeves 24B, D is carried out as previously described. FIG. 23(c) in plan shows all four sets of core formers 23 and sleeves 24 and ropes 26 using vertical reels 100 ready for the next production cycle.

The factory operators then prepare casting line 1 for the next cast. If the next production requirement is for a similar length and slab section 20 of hollowcore slabs 3 as the previous cast, base plates 7 and strand wire locator plates are left in position. However if there are different slab sections 20 or lengths of hollowcore slabs 3 to be cast, all the base plates 7 and strand wire locating plates are removed, once again availing the use of carriage 27a as previously described. The factory operators once again measure individual hollowcore slab 3 lengths required to be cast as previously described.

The factory production cycle as previously described is now repeated.

Ruching tubes 116 have not been described or shown in the second and third method of preparing the individual horizontal or vertical reels 100 resting on 101 and storage platform 102. See FIGS. 19(b), 19(d). However at the end of platform 102 there is ample space to accommodate a temporary single ruching tube 116 to prepare core formers 23 as sleeves 24 for the next production casting operation. Individual horizontal or vertical reels 100 with fully wound up core former 23 and sleeve 24 can be loaded onto the central shaft 112 or 114.

The laying of the core former 23 and sleeve 24 down casting bed 1 would follow immediately the core former 23 and sleeve 24 has been ruched onto the tube 116. Thereafter the empty horizontal or vertical reel 100 is removed and another reel 100 located onto the platform 102 and the second core former 23 and sleeve 24 is ruched up and immediately laid down casting bed 1.

Ruching operations for the hand method of removing core former 23 and sleeve 24 as shown in FIG. 19(a) is simply carried out with a single mobile ruching tube to enable factory operators to carry out the laying of the individual core formers 23 and sleeve 24 immediately after the ruching operation has been completed.

The fourth and fifth method of laying core formers 23 and sleeves 24 in FIG. 6(a) involve the use of shaft 27 and carriage 27a. However, platform 102 with horizontal or vertical reels 100, storing fully wound up core formers 23 and sleeves 24, is still in the stock area. The operators move platform 102, FIG. 22(a), for the horizontally wound reels 100 back to behind end 17 to line up the tubes 116 with the end of casting line 1. Carriage 27a is moved down from end 16 along rail 2a and placed at end 13 close to the end of platform 153. Shaft 27 with ropes 26 attached to all four core formers 23A, B, C, D and sleeves 24A, B, C, D is now removed from the two arms 118 and repositioned on carriage 27a, FIG. 24(a). Deflector plate 125 located temporarily onto the end of both arms 118 serves to ensure ropes 26 followed by core formers 23 and sleeves 24 leave ends 116a centrally to avoid excessive abrasion on sleeves 24. Core formers 23 and sleeves 24 are winched down casting line 1 as previously described at the same time unwinding from the four reels 100 on platform 102. With the core formers 23 and sleeves 24 fully unwound, hooked ropes 98 are released from the ring eyes 29 at the end of core former 23. Reels 100 are rotated to wind up hooked ropes 98 until the hooked end protrudes from each tube 116 at end 116a in FIG. 24(b). Platform 102 is moved away from casting line 1 and stored in the stock area, to allow production operations as previously described to continue.

Core formers 23 and sleeves 24 on vertical reels 100 are unwound and laid down casting line 1 in a similar but two phase operation. For the first phase empty carriage 27a is again moved down from end 16 and parked at end 13.

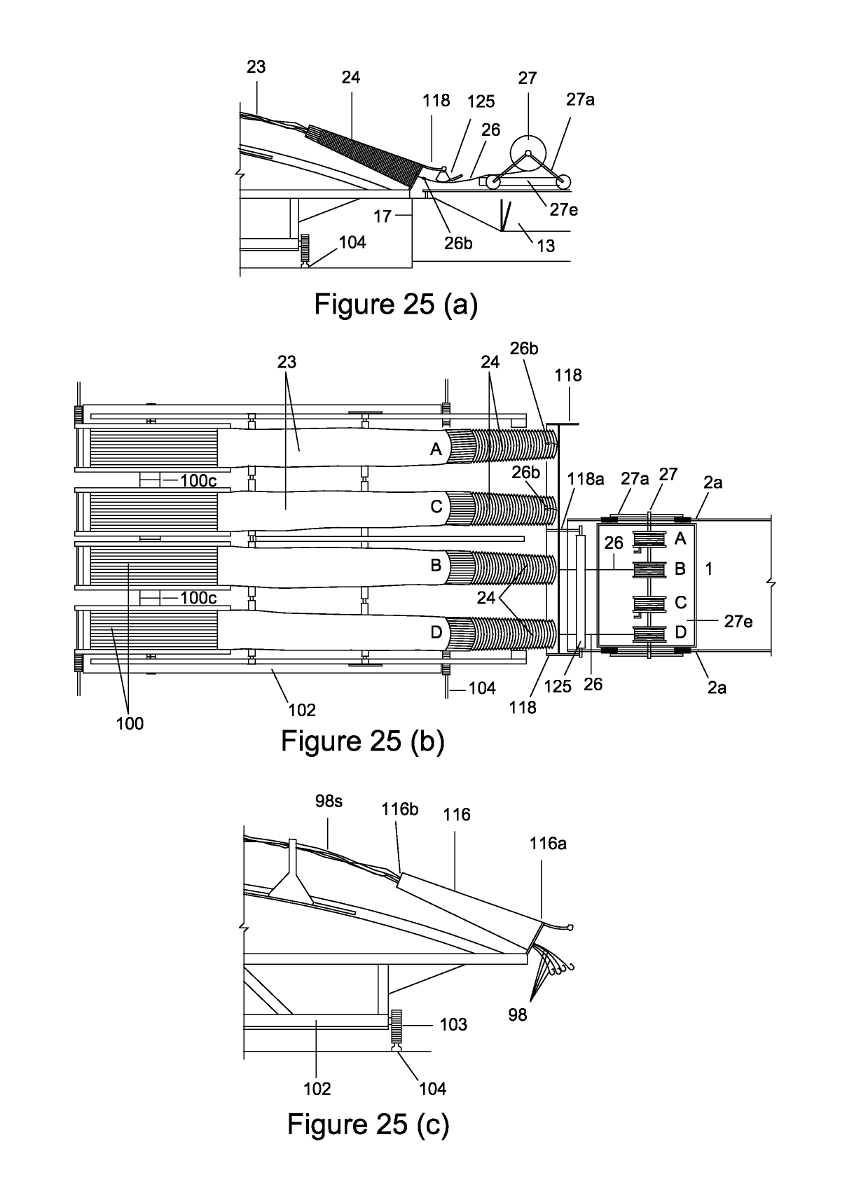

Platform 102, shown in FIG. 23(c), is now moved back to behind end 17 to line up tube 116 so to remove core formers 23B, D and sleeves 24B, D. Shaft 27 is removed from arms 118 and arms 118a and repositioned on carriage 27a. Deflector plate 125 is placed on arms 118 and arms 118a, see FIG. 25(a) and FIG. 25(b), and the laying operations of core formers 23B, D and sleeves 24B, D continue as previously described. Once complete, hooked rope 90 is unhooked from 29 attached to core formers 23B, D at end 13.

The second phase of laying core formers 23 and sleeves 24 is then carried out. Platform 102 is moved along rails 104 to line up tube 116 to remove core formers 23A, C and sleeves 24A, C. Pins 26b are separated on ropes 26 for core formers 23B, D and sleeves 24B, D whilst shaft 27 on carriage 27a remains past end 16. Thereafter carriage 27a is brought back to end 13. The loose ends of ropes 26 on the two reels on shaft 27 for core formers 23A, C and sleeve 24A, C are joined to the ropes 26 via pins 26b, in FIG. 25(a). Deflector plate 125 is relocated on the arms 118 and arms 116a and the laying operation for core formers 23A, C and sleeve 24A, C continues as previously described. Finally hooked ropes 48 are released from ring eyes 29 attached to core formers 23 and platform 102, FIG. 25(c), is moved away to the stock area to allow production operations as previously described to continue.

Although the core formers and sleeves are round or oval, other shapes can be considered, such as square. The core formers and sleeves are also preferably of uniform lateral cross-section along the majority of their longitudinal extents.

Although the shutters are pivotable, they may be fixed side walls. Additionally and/or alternatively, the shutters may be raisable and lowerable.

The prestressing elongate flexible elements are preferable, but may be dispensed with in some circumstances.

It is thus possible to provide hollowcore apparatus and a method of forming hollowcore slabs which is compact, utilises a low-pressure compressed air system, and which can incorporate cross-reinforcement, cross-galleries, and lifting hooks prior to casting. Production of hollow core slabs can be doubled, and far less environmentally damaging by-products are produced. Different dimensions of hollowcore slabs can also be produced easily from a single casting bed and single set of shutters.

The present invention enable the manufacture of individual hollowcore slabs in the any length in a range between 5 to 25 metres to the nearest centimetre without the need for high capital cost hollowcore machinery and complicated saws. The invention further eliminates the current modern day health and safety issues, since the process is virtually silent and will require very little mechanical or hydraulic machinery to manufacture the hollowcore slabs. Multiple discrete slabs can also be cast on a single casting bed.

There is little or no wastage of materials in the production process. The casting operation is environmentally friendly and allows for small on site mobile plants to be set up quickly and economically. Equally large production facilities can be readily set up in distant locations in hot climates and in the open air, without the need for extensive factory sheds to shade the production area; essential with conventionally made Hollowcore slabs 3a to prevent shrinkage. This obviates the need, in some instances, of building an independent factory where necessary planning permission may not be granted. Further on site manufacture eliminates entirely complex road delivery problems and related costs, one reason why long span hollowcore slabs cannot be practically used in dense urban areas, not to mention the substantial savings in CO₂.

The concrete mix used in the new process is preferably Self Compacting Concrete (SCC), a type of concrete which is fluid at the time of placing and does not need compacting effort to consolidate it in the mould.

The hollowcore slabs of the invention are made using prestressing strands stressed in short or long casting lines, but in the new process, secondary unstressed reinforcement can be fitted, together with connectors and any other embedded fittings before or after the core formers are in position. The concrete is then simply poured into the mould and needs no vibration to produce the required strength.

The core formers, circular or oval, can be inflated, or otherwise deployed in position so that they may be readily disassembled before the slab is demoulded. The inflated core former can be inflated to a sufficient pressure to ensure that the weight of the fluid concrete around it does not distort it to an unintended cross section. The core former is held down by holders to stop flotation in the fluid concrete with either externally fixed steel clips or collars which are linked to stressed tendons in the slab.

The core formers use modern materials and may be made of nylon or similar material. The former is be sleeved, typically with a modern composite material, again nylon or similar, to ensure that the inner inflated core former and or mechanism is not contaminated by the wet concrete.

The apparatus of the invention also has the advantage that end plates or stop ends can be fitted into the line before the slabs are cast to allow them to be cast discretely, not continuously, removing the need for a concrete hydraulic saw. The only cutting that is required is to separate the steel strands linking the slabs after the line is detensioned and this is simply done using hand held tools or automated machinery; or if desired mechanised cutting apparatus, specifically to cut steel only, in large factories with a high production output can be used.

There is a substantial reduction in the use of electricity and potable water reducing CO2 emissions from the overall production process.

The apparatus of the invention ensures that all the wires and strands located in the individual slabs are precisely located to meet design and fire regulations.

The apparatus of the invention allows for the incorporation of special linking steel bars or welded mesh to ensure hollowcore slabs meets all earthquake zone codes of practice as well as meeting all European, American and Asian building codes. Special adaptors can be bonded into the sides of the hollowcore slab before casting to allow for a simple ‘mechanical’ connection between adjacent hollowcore slabs at any required distance along the length of any hollowcore slab.

All the necessary lifting sockets or loops essential to lift and move a slab, according to current health and safety regulations can be incorporated into the hollowcore slab before casting.

Water pipes, as required, can now be inserted into individual moulds before casting. Cores or voids can also be created in the same hollowcore section, allowing two technologies, for example, Thermocast® and TermoDeck®, a ventilation technology, using the cores or voids as a means to assist in heating and cooling as well as providing the necessary fresh air for the occupants of a room below to be incorporated together into a single slab.

Cross connections between adjacent voids/cores to allow passage of air between individual voids or cores or multiple voids or cores can now be simply incorporated into individual slab lengths before casting. This entirely eliminates the need for on-site drilling operations. Provision for inlets and outlets into the soffit of the hollowcore slab can also be inserted in the slab before casting, again obviating all need for vacuum-anchoring upwards special core drilling equipment, for example.

SCC may blend in steel fibres as an additive during the mixing process. There will be no segregation or bunching of the fibres giving even distribution over the complete hollowcore section and reducing the need for secondary reinforcement for longer spans of hollowcore slabs.

The block-out elements, whether they are providing access to an exterior of the slab or are interconnecting adjacent cores, are preferably oval, but may be circular or polygonal, such as square or rectangular.

The prestressing elongate flexible elements or wires are preferably multi-stranded, but may be single stranded, especially in the case of smaller slabs, such as for walls.

The gallery between cores is intended to provide for gas movement, typically being air. However, it could potentially provide for liquid movement.

Although not in the embodiments described, the sleeves may be sacrificial and therefore may be retained and lost in the finished hollowcore slab. To this end, the material that the sleeves are formed from may be chosen accordingly.

The present invention also allows hollowcore slabs to be made which are kinked or cranked in elevation. These units are of particular use in multi storey car parks where hollowcore currently cannot make ramp slabs without having columns and cross beams at each change of slope. A hollowcore cranked ramp slab formed using the method and apparatus of the present invention is significantly more cost-effective to produce.

A hollowcore slab can also now be cast with half jointed end by using the present invention so that its soffit does not automatically have to be placed on top of supporting beams or walls.

The use of Self Compacting Concrete in the present invention dispenses with the necessity of vibrational compacting presently utilised and the associated health risks to employees. However, vibration units can be utilised if by chance self compacting mix constituents are not available locally.

What is claimed is:

1. A hollowcore apparatus for forming a concrete hollowcore slab, the apparatus comprising a casting bed, side wall elements extending longitudinally of the casting bed which define sides of a casting mould, at least one non-sacrificial inflatable core former, at least one non-sacrificial sleeve in which at least part of the core former is receivable, the core former and the sleeve being interconnected and the in use sleeve being turnable inside out by removal of the core former from the casting bed, and at least one holder which prevents or limits uplift of the in use inflated core former and sleeve relative to the casting bed.

2. The hollowcore apparatus of claim 1, wherein said core former and sleeve are interposed between a single or multiple prestressing elongate flexible element or groups thereof.

3. The hollowcore apparatus of claim 2, further comprising a lateral anchor which anchors the elongate prestressing flexible element laterally to prevent or limit uplift thereof.

4. The hollowcore apparatus of claim 3, wherein the said holder includes an upwardly projecting lifting loop element integrally formed as one piece for releasable connection to a slab lifting device.

5. The hollowcore apparatus of claim 1, further comprising a blanking element which is locatable in a casting bay defined along the casting bed for blanking a portion of the hollowcore slab. wherein the blanking element is at an end of the casting bay for forming a half-jointed end on the hollowcore slab.

6. The hollowcore apparatus of claim 1, further comprising at least one block-out element for contacting the sleeve on its longitudinal extent to provide an access opening to an interior of a core of the hollowcore slab along its longitudinal extent.

7. The hollowcore apparatus of claim 6, wherein the block-out element extends between adjacent said sleeves so as to provide a cross-connecting fluid-flow channel between adjacent cores.

8. The hollowcore apparatus of claim 6, wherein the block-out element is a corrugated duct which promotes heat exchange.

9. The hollowcore apparatus of claim 1, further comprising at least one of a surface plate with embedded anchoring reinforcement, a threaded socket, a sensor, a lifting loop, a cable conduit box, electrical cable, and a fluid-flow pipe.

10. The hollowcore apparatus of claim 1, further comprising a ruching tube which niches at least the sleeve.

11. A method of forming a concrete hollowcore slab, the method comprising the steps of: a) preparing a casting mould; b) locating at least one non-sacrificial inflatable core former having a non-sacrificial sleeve connected thereto in the casting mould; c) providing at least one holder which prevents or limits uplift of the inflated core former and sleeve; d) inflating the core former; e) pouring concrete into the casting mould to cover the core former and sleeve; f) deflating the core former and the sleeve once the concrete hardens, and removing the core former and the sleeve by drawing the core former out causing the connected sleeve to turn inside out and thus also be drawn out; and g) removing the hollowcore slab from the casting bed.

12. The method of claim 11, further comprising a step subsequent to step f) of ruching the said inside out sleeve and drawing the core former therethrough to turn the sleeve back to its original condition ready for the next casting operation.

13. The method of claim 11, wherein a plurality of core formers and sleeves are provided which form multiple cores and, in step f), a plurality of independent core former and sleeve winding reels are provided which simultaneously wind a plurality of core formers and sleeves whilst keeping an angle of deflection to a minimum.

14. The method of claim 11 further comprising a step prior to step e) of inserting at least one straight or bent reinforcing bar element into the casting mould which provides additional shear reinforcement of the hollowcore slab.

15. The method of claim 11, wherein the concrete in step e) includes reinforcement fibres dispersed throughout which impart shear reinforcement.

16. The method of claim 11, wherein the concrete in step e) includes polymeric fibres throughout which direct steam during fire.

17. A method of forming a concrete hollowcore slab, the method comprising the step of pouring concrete into a casting mould having therein at least one non-sacrificial inflated core former having a non-sacrificial sleeve therearound, the core former and sleeve being interconnected at one end so that on withdrawal of the core former the sleeve is turned inside out, the inflated core former and sleeve being restrained against substantial uplift by a holder in or on the casting mould.

18. A hollowcore slab formed using hollowcore apparatus as claimed in claim 1, and self-compacting concrete.

19. The hollowcore slab of claim 18, having a fluid-flow pipe therein whereby the hollowcore slab is adapted for use as a thermal energy store and/or secondary radiator.

20. A hollowcore slab as formed using the hollowcore apparatus of claim 1, comprising embedded stressed and unstressed reinforcement.
